(19) United States
(12) Patent Application Publication
(10) Pub. No.: US 2025/0274521 A1
(43) Pub. Date: Aug. 28, 2025

(54) GENERATIVE AI FOR SUMMARIZING WEB SESSIONS

(71) Applicant: Quantum Metric, Inc., Colorado Springs, CO (US)

(72) Inventors: Mario Luciano Ciabarra, JR., Boulder, CO (US); Adam Dille, Monument, CO (US); Yiduo Wang, Vancouver, WA (US); Daniel Saul Eisenberg Keogh, Brooklyn, NY (US)

(73) Assignee: Quantum Metric, Inc., Colorado Springs, CO (US)

(21) Appl. No.: 19/064,384

(22) Filed: Feb. 26, 2025

Related U.S. Application Data
(60) Provisional application No. 63/557,697, filed on Feb. 26, 2024.

(51) Int. Cl. H04L 67/1396

(52) U.S. Cl. CPC H04L 67/1396

(57) ABSTRACT

The method includes: obtaining, from a capture agent on a user device, captured data for a set of captured user interactions with the network site during the network session, wherein the set of captured user interactions includes movements between portions of the network site; analyzing the captured data to identify a set of events; extracting event data corresponding to the set of events; receiving a request for a textual description of the network session; generating a prompt for a language model, using the request and the event data; providing the prompt as an input to the language model; and receiving the textual description from the language model. The textual description is provided to a computer associated with the network site.

### CROSS-REFERENCE TO RELATED APPLICATION(S)

This application is a non-provisional of and claims the benefit of the filing date of U.S. Provisional Patent Application No. 63/557,697, filed Feb. 26, 2024, the disclosure of which is incorporated by reference herein in its entirety.

### BACKGROUND

The website developers and providers do not have a clear insight into how their audience is using and interacting with the web documents or web applications because web document content can be modified within the user's browser. Traditionally, the network to desktop browsers was viewed as reliable and adhering to fairly consistent and predictable performance patterns. In the new environment where users increasingly access data from any device, and over widely varying network conditions, the proposition that performance is consistent is no longer valid.

Accordingly, providers, designers, operators, and web document creators seek an accurate and efficient way to capture how users interact with their web documents to playback and analyze the remote interactions. However, because of the large amount of permutations of how users can interact with an individual document or groups of documents on the website, accurately and timely capturing, analyzing, and presenting the information representative of users' interactions with the websites remains problematic.

### SUMMARY

Embodiments of the present disclosure provide systems, methods, and apparatuses for addressing the above problems by capturing the data related to the user interactions with the website and using the large language model (LLM) to analyze the captured data and generate a summary describing the user intent with regard to the web session, encountered difficulty with the website (if any), and the outcome of the web session.

Some embodiments include a method for generative artificial intelligence of user interactions with a network site during a network session, the method being performed by one or more processors of a computer system. The method includes: obtaining, from a capture agent on a user device, captured data for a set of captured user interactions with the network site during the network session, where the set of captured user interactions includes movements between portions of the network site; analyzing the captured data to identify a set of events; extracting event data corresponding to the set of events; storing the event data at a storage location accessible by a language model; receiving a request for a textual description of the network session; generating a prompt for the language model, using the request and the event data; providing the prompt as an input to the language model; receiving the textual description from the language model; and providing the textual description to a computer associated with the network site.

The set of captured user interactions further includes data provided in one or more fields on the network site.

Some embodiments include a method for generative artificial intelligence of user interactions with a network site during a network session, the method being performed by one or more processors of a computer system. The method includes: obtaining, from a capture agent on a user device, captured data for a set of captured user interactions with the network site during the network session, where the set of captured user interactions includes (1) movements between portions of the network site and (2) timestamps for one or more events during the network session; generating, by a language model, a textual description of the network session using the captured data, the textual description summarizing the one or more events, the one or more events being linked to the timestamps corresponding to the one or more events; providing a user interface for a client device to view a playback of a replay session of the network session, the user interface displaying a first indicator corresponding to a first event; and responsive to a client interacting with the first indicator, providing, to the client device, the textual description corresponding to a timestamp that is associated with the first indicator and linked to the textual description.

Some embodiments include a method for generative artificial intelligence of user interactions with a network site during a network session, the method being performed by one or more processors of a computer system. The method includes obtaining, from a capture agent on a user device, captured data for a set of captured user interactions with the network site during a set of network sessions, where the set of captured user interactions includes (1) movements between portions of the network site and (2) timestamps for one or more events during the network session; receiving a request for a set of combined textual descriptions corresponding to the set of network sessions; generating a prompt for the language model using the request; providing the prompt and event data of the set of network sessions as inputs to the language model, the prompt instructing the language model to identify a plurality of intents within the event data, each of the plurality of intents relating to a group of events that occurred within the set of network sessions, where each group of events occurred between a first timestamp and a last timestamp that are specific to each group of events; receiving, from the language model, the set of combined textual descriptions, each textual description of the set of combined textual descriptions summarizing the events included in each group of events, where the events are linked to timestamps corresponding to the events; and providing the set of combined textual descriptions to one or more computers associated with the network site.

In some embodiments, the method further includes providing a user interface for a client device to view a playback of a replay session of the network session; responsive to a client interacting with the user interface, providing, to the client device, a plurality of textual descriptions from the set of combined textual descriptions; and displaying, on the user interface, the plurality of textual descriptions in correspondence to the timestamps.

In some embodiments, the displaying further includes: overlaying the playback of the replay session with spans, where each of the spans corresponds to one of the plurality of textual descriptions and describes events occurring in a time period corresponding to each of the spans.

Some embodiments include a method for generative artificial intelligence of user interactions with a network site during a set of network sessions, the method being performed by one or more processors of a computer system. The method includes, for each network session of the set of network sessions, obtaining, from a capture agent on a user device, captured data for a set of captured user interactions with the network site during the network session, where the set of captured user interactions includes movements between portions of the network site, and generating, by a language model, a session-specific textual description of the network session using the captured data, thereby generating a set of session-specific textual descriptions. The method further includes receiving a request for a combined textual description of the set of network sessions; generating a prompt for the language model using the request; providing the prompt and the session-specific textual descriptions as inputs to the language model; receiving the combined textual description from the language model; and providing the combined textual description to a computer associated with the network site.

These and other embodiments of the disclosure are described in detail below. For example, other embodiments are directed to systems, devices, and computer-readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 illustrates an example of a distributed computer system according to at least one embodiment.

FIG. 2 shows a block diagram of an exemplary generative AI system, in accordance with some embodiments.

FIG. 3 shows an example of an architecture of a large language model (LLM), in accordance with some embodiments.

FIG. 4 shows an example of a summary, in accordance with some embodiments.

FIG. 5A shows an example of a summary, in accordance with some embodiments.

FIG. 5B shows an example of a summary, in accordance with some embodiments.

FIG. 6 is a simplified block diagram of a processing performed by the generative AI system in accordance with various embodiments.

FIG. 6 is a simplified block diagram of a processing performed by the generative AI system in accordance with various embodiments.

FIG. 7 is a simplified block diagram of a processing performed by the generative AI system in accordance with various embodiments.

FIG. 8 is a simplified block diagram of a processing performed by the generative AI system in accordance with various embodiments.

FIG. 9 is a simplified block diagram of a processing performed by the generative AI system in accordance with various embodiments.

FIG. 10 is a simplified block diagram of a processing performed by the generative AI system in accordance with various embodiments.

FIG. 11 is a simplified illustration of a graphical user interface, in accordance with various embodiments.

FIG. 12 is a simplified illustration of a graphical user interface, in accordance with various embodiments.

FIG. 13 is a simplified illustration of a graphical user interface, in accordance with various embodiments.

FIG. 14 is a simplified illustration of a graphical user interface, in accordance with various embodiments.

FIG. 15 shows a block diagram of an exemplary computer system, in accordance with some embodiments.

### TERMS

Prior to further describing embodiments of the disclosure, description of related terms is provided.

A “user” can be a person or thing that employs some other thing for some purpose. A user may include an individual that uses a user device and/or a website. The user may also be referred to as a “consumer” or “customer” depending on the type of the website.

A “user device” may include any suitable computing device that can be used for communication. A user device may also be referred to as a “communication device.” A user device may provide remote or direct communication capabilities. Examples of remote communication capabilities include using a mobile phone (wireless) network, wireless data network (e.g., 3G, 4G, 5G or similar networks), Wi-Fi, Wi-Max, or any other communication medium that may provide access to a network such as the Internet or a private network. Examples of user devices include desktop computers, mobile phones (e.g., cellular phones), PDAs, tablet computers, net books, laptop computers, etc. Further examples of user devices include wearable devices, such as smart watches, fitness bands, ankle bracelets, etc., as well as automobiles with remote or direct communication capabilities. A user device may include any suitable hardware and software for performing such functions, and may also include multiple devices or components (e.g., when a device has remote access to a network by tethering to another device—i.e., using the other device as a modem—both devices taken together may be considered a single communication device).

A “server computer” may include a powerful computer or cluster of computers. For example, the server computer can be a large mainframe, a minicomputer cluster, or a group of computers functioning as a unit. In some cases, the server computer may function as a web server or a database server. The server computer may include any hardware, software, other logic, or combination of the preceding for servicing the requests from one or more other computers. The term “computer system” may generally refer to a system including one or more server computers.

A “processor” or “processor circuit” may refer to any suitable data computation device or devices. A processor may include one or more microprocessors working together to accomplish a desired function. The processor may include a CPU that includes at least one high-speed data processor adequate to execute program components for executing user and/or system-generated requests. The CPU may be a microprocessor such as AMD's Athlon, Duron and/or Opteron, etc.; IBM and/or Motorola's PowerPC; IBM's and Sony's Cell processor; Intel's Celeron, Itanium, Pentium, Xeon, and/or Xscale, etc.; and/or the like processor(s).

A “memory” or “system memory” may be any suitable device or devices that can store electronic data. A suitable memory may include a non-transitory computer readable medium that stores instructions that can be executed by a processor to implement a desired method. Examples of memories may include one or more memory chips, disk drives, etc. Such memories may operate using any suitable electrical, optical, and/or magnetic mode of operation.

In this disclosure, the term “user interactions” relates generally to any user experience that may occur during a web session, such as, for example, a technical error, a server error, slow page loads, user properties (e.g., loyalty level, signed-in state), custom events and errors, data captured from other technologies at the client device, user clicks, user scrolls, typing, navigation, pop-up screens, prompts, etc.

A “web session” or “session” generally refers to a set of user interactions with a website. The session may include interactions starting with a user accessing a webpage of the website (e.g., using a web browser or other software application) and ending with the user ceasing interactions with the website (e.g., closing a webpage of the website within the web browser or software application). The time-length of the session in seconds, minutes, and/or hours can be determined based on a start time when the user first interacted with the website to an end time of the last interaction made by the user. The web server hosting the website may store an identifier of the session and other information associated with the session (e.g., elements or items of the website selected by the user, or information input by the user).

A native application may refer to an application that is configured for a particular type of platform and/or particular type of device, e.g., a native environment on the device, as opposed to a browser that may download software to run locally on the device.

As used herein, a webpage may refer to a page of the application accessible from the website. Although examples in the present disclosure may refer to a webpage, such examples equally apply to any page of an application, such as a native application or a kiosk application. Thus, a webpage may refer to a page of an application, including a native application, a kiosk application, etc.

A session may include one or more “stages” that a user progresses through until the user ends the session. The “stages” may be defined based on interactions made by the user (e.g., opening a webpage, selecting an element or item of the page, or inputting information in a particular location). For example, each stage may be associated with a particular interaction that is occurring during the stage (e.g., opening a page, selecting an element, or submitting data) and a particular interaction that ends the stage (e.g., opening another page, selecting another element, or submitting other data). Each stage may be associated with one or more changes or updates to a webpage (e.g., a visual change or a change in the information obtained by the web server). For example, each webpage of the website presented to the user may correspond to a different stage. In some examples, stages may be a combination of multiple different webpages and/or different interactions with particular webpages. Each of the stages may be associated with a unique identifier.

An example of a set of stages during a session is provided below. In this example, a user opens a homepage of a website, which is associated with a first stage. During the first stage, the user browses the page and selects a link to open a second page on the website, thereby ending the first stage and beginning a second stage. The second stage can be associated with the second page. During the second stage, the user browses the second page and inputs information to the second page by selecting items or elements of the page or by inputting text into a field of the second page. This information is submitted to the website (which can be performed automatically by the website or performed manually by the user selecting a submit button). The submission of such information can end the second stage and beginning a third stage. The third stage can be associated with a third page. The third page may present confirmation of the information selected or input by the user. Not every session with a particular website will include the same stages nor will the stages always occur in the same order. Different sessions may include different stages and the stages may occur in different orders. A particular stage or sequence of stages may occur more than once in a given session. In addition, while the stages are described as being associated with a particular “webpage,” the stages can be associated with particular in-line updates to blocks, fields, or elements of the same webpage (e.g., the same URL).

A “conversion” or “conversion event” generally refers to a digital interaction by a user that achieves a particular result or objective. For example, a “conversion” can include a user placing an order, registering for a website, signing up for a mailing list, opening a link, or performing any other action. As such, a mere “visitor” to a website has been converted into a “user” or “consumer” of the website. The conversion process may involve one or more intermediate actions taken by the user to achieve the result of objective. For example, a conversion process for placing an order can include the intermediate steps of visiting a website, selecting one or more items, adding one or more items to an order, selecting parameters for the order, inputting order information, and submitting the order. In another example, a conversion process for a user registering with a website can include the intermediate steps visiting the website, selecting a registration link, inputting an email address, and submitting the email address.

The term “machine learning model” may refer to a program, file, method, or process, used to perform some function on data, based on knowledge “learned” during a training phase. For example, a machine learning model can be used to classify feature vectors as normal or anomalous. In “supervised learning,” during a training phase, a machine learning model can learn correlations between features contained in feature vectors and associated labels. After training, the machine learning model can receive unlabeled feature vectors and generate the corresponding labels. For example, during training, a machine learning model can evaluate labeled images of dogs, then after training, the machine learning model can evaluate unlabeled images, in order to determine if those images are of dogs. In “unsupervised learning,” an ML model or algorithm is provided with unlabeled data, and is tasked to analyze and find patterns in the unlabeled data.

Machine learning models may be defined by “parameter sets,” including “parameters,” which may refer to numerical or other measurable factors that define a system (e.g., the machine learning model) or the condition of its operation. In some cases, training a machine learning model may include identifying the parameter set that results in the best performance by the machine learning model. This can be accomplished using a “loss function,” which may refer to a function that relates a model parameter set to a “loss value” or “error value,” a metric that relates the performance of a machine learning model to its expected or desired performance.

The term “providing” may include sending, transmitting, displaying or rendering, making available, or any other suitable method. While not necessarily described, messages communicated between any of the computers, networks, and devices described herein may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

### DETAILED DESCRIPTION

Embodiments can provide systems, methods, and apparatuses for providing, by the LLM, summaries of user interactions with a website.

Users of websites and software applications can experience issues such as a delay in loading a webpage, software bugs, or interface design flaws that hinder them from taking certain actions (e.g., registering for a website or placing an order). In some cases, the issue may cause the user to abandon the website out of frustration. Such issues might not be identified by a web server hosting the website because the issues arise out of the generating and rendering of a webpage by the user's browser on a user device over Application Programming Interface (API) calls by the user's browser.

Techniques for identifying issues with websites may include monitoring user activities across the entire website. While activity monitoring can help identify whether users are abandoning the website or not performing certain actions, it does not help identify which elements of particular webpages are causing the user to abandon the website and user activities are impacting the website's performance.

Certain related methods also do not provide impacts of certain user experiences on webpages of a website on overall website's performance. If an issue with a webpage (e.g., delay in loading the webpage) of a website has an impact on website's performance then the issue may require an immediate attention of a website provider. If the website provider is unaware of impacts of issues on the website's performance, issues requiring immediate attention might not be investigated with high priority.

The embodiments disclosed herein provide improved systems and methods to analyze deviations in user interactions on webpages, identify network operations responsible for causing the deviations in user interactions, and provide machine-generated summary describing the user's actions, the frustrating events (e.g., “friction”), and a possible resolution.

An overview of the distributed computer system is described first, followed by the description of the generative AI for summarizing web sessions.

### I. Distributed Computer System

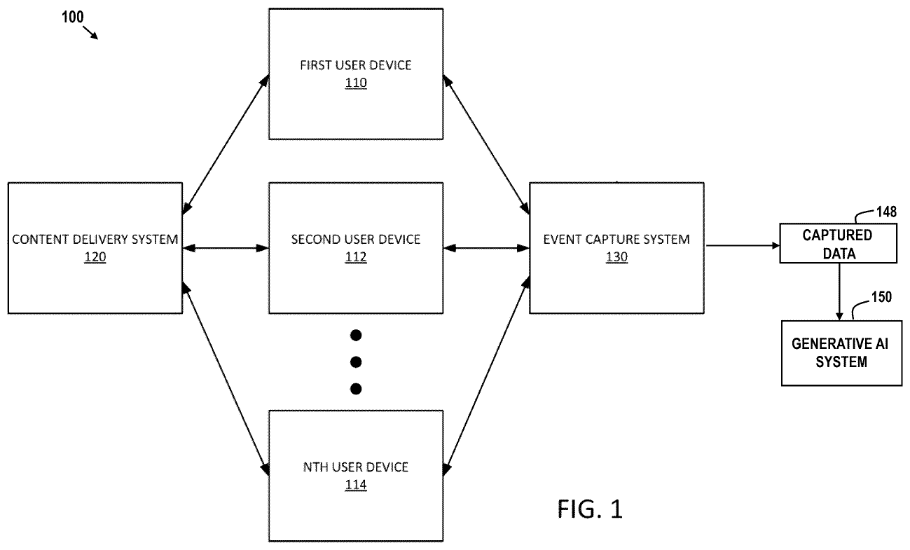

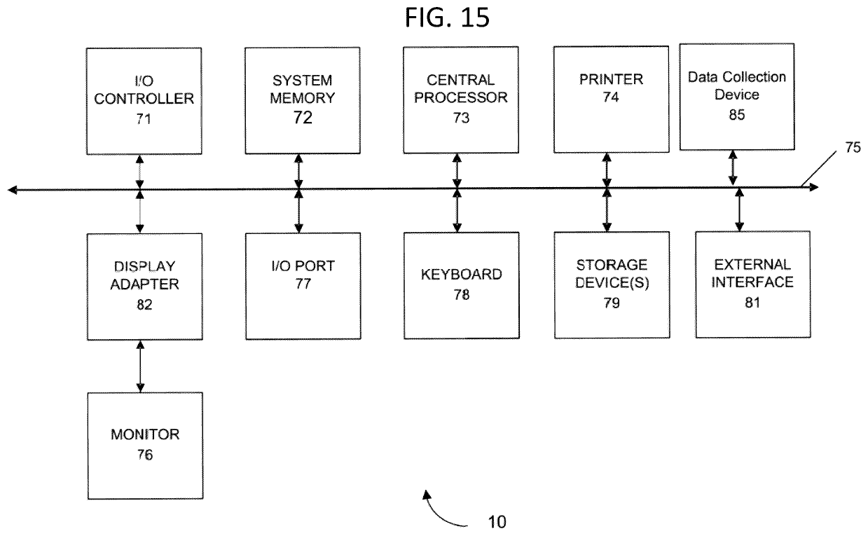

FIG. 1 illustrates an example of a distributed computer system 100 for analyzing a website's performance according to certain embodiments. The distributed computer system 100 may be implemented using one or more computer systems, each computer system having one or more processors. The distributed computer system 100 may include multiple components, devices, systems, and/or subsystems communicatively coupled to each other via one or more communication mechanisms. For example, in the embodiment shown in FIG. 1, the distributed computer system 100 includes a content delivery system 120, an event capture system 130, and a generative AI system 150. These systems may be implemented as one or more computer systems. The systems, subsystems, and other components shown in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The distributed computer system 100 shown in FIG. 1 is merely an example and is not intended to unduly limit the scope of embodiments. Many variations, alternatives, and modifications are possible. For example, in some implementations, distributed computer system 100 may have more or fewer systems or components than those shown in FIG. 1 or may have a different configuration or arrangement of systems. The systems shown in FIG. 1 may be implemented using one or more computer systems, such as the computer system shown in FIG. 15.

### A. User Interactions With Webpages

The distributed computer system 100 may include one or more user devices, such as a first user device 110, a second user device 112, and an Nth user device 114. Each of the one or more user devices may be operated by a different user. For example, a user may be using an application for presenting content on a user device. The application may be a browser for presenting content from many different sources using uniform resource locators (URLs) to navigate to the different sources or an application associated with a defined number of one or more sources (e.g., an enterprise application for content associated with an enterprise).

The content delivery system 120 may be implemented to store content, such as electronic documents (e.g., a collection of web documents for a website). In one illustrative example, content delivery system 120 may be a web server that hosts a website by delivering the content.

The one or more user devices (e.g., first user device 110, second user device 112, and Nth user device 114) may communicate with content delivery system 120 to exchange data via one or more communication networks. Examples of a communication network include, without restriction, the Internet, a wide area network (WAN), a local area network (LAN), an Ethernet network, a public or private network, a wired network, a wireless network, and the like, and combinations thereof.

In one illustrative example, the first user device 110 may exchange data with content delivery system 120 to send instructions to and receive content from content delivery system 120. For example, the first user device 110 may send a request for a webpage to content delivery system 120. The request may be sent in response to a browser executing on the first user device 110 navigating to a uniform resource locator (URL) associated with content delivery system 120. In other examples, the request may be sent by an application executing on the first user device 110

In response to the request, content delivery system 120 may provide the webpage (or a document to implement the webpage, such as a Hypertext Markup Language (HTML) document) to the first user device 110. In some examples, the response may be transmitted to the first user device 110 via one or more data packets.

While the above description relates primarily to providing webpages, it should be recognized that communications between user devices and content delivery system 120 may include any type of content, including data processed, stored, used, or communicated by an application or a service. For example, content may include business data (e.g., business objects) such as JavaScript Object Notation (JSON) formatted data from enterprise applications, structured data (e.g., key value pairs), unstructured data (e.g., internal data processed or used by an application, data in JSON format, social posts, conversation streams, activity feeds, etc.), binary large objects (BLOBs), documents, system folders (e.g., application related folders in a sandbox environment), data using representational state transfer (REST) techniques (referred to herein as “RESTful data”), system data, configuration data, synchronization data, or combinations thereof. A BLOB may include a collection of binary data stored as a single entity in a database management system, such as an image, multimedia object, or executable code, or as otherwise known in the art. As an example, content may include an extended markup language (XML) file, a JavaScript file, a configuration file, a visual asset, a media asset, a content item, etc., or a combination thereof.

The event capture system 130 may capture, store, provide, and regenerate events that occur on user devices. For example, a user device may display a webpage. In such an example, event capture system 130 may capture one or more interactions with the webpage that occur on the user device, such as movement of a mouse cursor, clicking on a certain button, activation of a user-selectable option, or the like. The capture system 130 may also capture timing values for different events for webpages of a website. As illustrated in FIG. 1, the event capture system 130 may be communicatively coupled (e.g., via one or more networks) to each of one or more user devices. For example, the event capture system 130 may be communicatively coupled to first user device 110. In some examples, instead of being separate from the user devices, an instance (not illustrated) of event capture system 130 may be executing on each of the user devices. In such examples, an additional portion of event capture system 130 may be separate from each of the user devices, where the additional portion communicates with each instance. In addition or in the alternative, event capture system 130 may be communicatively coupled to content delivery system 120 via a communication connection.

Each of first user device 110, second user device 112, Nth user device 114, content delivery system 120, event capture system 130, and/or generative AI system 150 may include one or more computers and/or servers which may be general purpose computers, specialized server computers (including, by way of example, PC servers, UNIX servers, midrange servers, mainframe computers, rack-mounted servers, etc.), server farms, server clusters, distributed servers, or any other appropriate arrangement and/or combination thereof. Each of first user device 110, second user device 112, Nth user device 114, content delivery system 120, event capture system 130, and/or generative AI system 150 may run any operating system or a variety of additional server applications and/or mid-tier applications, including HTTP servers, FTP servers, CGI servers, Java servers, database servers, and the like. Exemplary database servers include without limitation those commercially available from Microsoft, and the like.

Each of first user device 110, second user device 112, Nth user device 114, content delivery system 120, event capture system 130, and/or generative AI system 150 may be implemented using hardware, firmware, software, or combinations thereof. In various embodiments, each of first user device 110, second user device 112, Nth user device 114, content delivery system 120, event capture system 130, and/or generative AI system 150 may be configured to run one or more services or software applications described herein. In some embodiments, content delivery system 120, event capture system 130, and/or generative AI system 150 may be implemented as a cloud computing system.

Each of first user device 110, second user device 112, Nth user device 114, content delivery system 120, event capture system 130, and/or generative AI system 150 may include several subsystems and/or modules, which might not be shown herein. Subsystems and/or modules of each of first user device 110, second user device 112, Nth user device 114, content delivery system 120, event capture system 130, and/or generative AI system 150 may be implemented in software (e.g., program code, instructions executable by a processor), in firmware, in hardware, or combinations thereof. The subsystems and/or modules of each of first user device 110, second user device 112, Nth user device 114, content delivery system 120, event capture system 130, and/or generative AI system 150 may be implemented to perform techniques disclosed herein.

In some embodiments, the software may be stored in a memory (e.g., a non-transitory computer-readable medium), on a memory device, or some other physical memory and may be executed by one or more processing units (e.g., one or more processors, one or more processor cores, one or more GPUs, etc.). Computer-executable instructions or firmware implementations of the processing unit(s) may include computer-executable or machine-executable instructions written in any suitable programming language to perform the various operations, functions, methods, and/or processes disclosed herein.

Each of first user device 110, second user device 112, Nth user device 114, content delivery system 120, event capture system 130, and/or generative AI system 150 may store program instructions that are loadable and executable on the processing unit(s), as well as data generated during the execution of these programs. The memory may be volatile (such as random access memory (RAM)) and/or non-volatile (such as read-only memory (ROM), flash memory, etc.). The memory may be implemented using any type of persistent storage device, such as computer-readable storage media. In some embodiments, computer-readable storage media may be configured to protect a computer from an electronic communication containing malicious code. The computer-readable storage media may include instructions stored thereon, that when executed on a processor, perform the operations disclosed herein.

Each of first user device 110, second user device 112, Nth user device 114, content delivery system 120, event capture system 130, and/or generative AI system 150 may also include or be coupled to additional storage, which may be implemented using any type of persistent storage device, such as a memory storage device or other non-transitory computer-readable storage medium. In some embodiments, local storage may include or implement one or more databases (e.g., a document database, a relational database, or other type of database), one or more file stores, one or more file systems, or combinations thereof.

Each of first user device 110, second user device 112, Nth user device 114, content delivery system 120, event capture system 130, and/or generative AI system 150 may provide some services and/or applications that are in a virtual or non-virtual computing environment. Such services may be offered on-demand to user devices. A user operating a user device may use one or more applications to interact and utilize the services or applications provided by content delivery system 120, event capture system 130, and/or generative AI system 150. Services may be offered as a self-service or a subscription. Users may acquire the application services without the need for customers to purchase separate licenses and support. Examples of services may include a service provided under a Software as a Service (SaaS) model, a web-based service, a cloud-based service, or some other service provided to a user device. In some embodiments, event capture system 130 and/or generative AI system 150 may host an application to interact with an application executing on a user device on demand. A user operating a user device may in turn utilize one or more applications to interact with content delivery system 120, event capture system 130, and/or generative AI system 150 to perform operations described herein.

In some examples, a service may be an application service provided by content delivery system 120, event capture system 130, and/or generative AI system 150 via a SaaS platform. The SaaS platform may be configured to provide services that fall under the SaaS category. The SaaS platform may manage and control the underlying software and infrastructure for providing the SaaS services. By utilizing the services provided by the SaaS platform, customers can utilize applications. The cloud computing system may be implemented as a cloud-based infrastructure that is accessible via one or more networks. Various different SaaS services may be provided.

A user device may include or be coupled to a display. A user device may provide access to one or more applications (also referred to herein as an “application program”). An application of the one or more applications may present content using the display. It should be recognized that an application may be executing on a user device, content delivery system 120, event capture system 130, generative AI system 150, or a combination thereof. In some embodiments, an application may be accessed from one location and executed at a different location. An application may include information such as computer-executable or machine-executable instructions, code, or other computer-readable information. The information may be written in any suitable programming language to perform the various operations, functions, methods, and/or processes disclosed herein. The information may be configured for operation of the application as a program. Examples of applications may include, without restriction, a document browser, a web browser, a media application, or other types of applications.

In some embodiments, an application may be device specific. For example, the application may be developed as a native application for access on a particular device that has a configuration that supports the application. The application may be configured for a particular type of platform and/or particular type of device. As such, the application may be implemented for different types of devices. Devices may be different for a variety of factors, including manufacturer, hardware, supported operating system, or the like. The application may be written in different languages, each supported by a different type of device and/or a different type of platform for the device. For example, the application may be a mobile application or mobile native application that is configured for use on a particular mobile device.

In some embodiments, an application may generate a view of information, content, and/or resources, such as documents. For example, the application may display content to view on a user device. The view may be rendered based on one or more models. For example, a document may be rendered in the application, such as a web browser using a document object model (DOM). The view may be generated as an interface, e.g., a graphical user interface (GUI), based on a model. The document may be rendered in a view according to a format, e.g., a hyper-text markup language (HTML) format. The interface for the view may be based on a structure or organization, such as a view hierarchy.

Event capture system 130 may capture or record content presented by a user device. For example, the content may be a view of a document. Such content may be received from content delivery system 120. A view may be generated for display in the application based upon content obtained from content delivery system 120. In some embodiments, the application is a native application, written using a language readable by device to render a resource, e.g., a document, in the application. The view in the application may change rapidly due to one or more interactions with the application.

As described above, the event capture system 130 may be implemented at least partially on a user device (e.g., client-side) where views are to be captured. In such embodiments, event capture system 130 may be implemented in a variety of ways on the user device. For example, event capture system 130 may be implemented as instructions accessible in a library configured on the user device. Event capture system 130 may be implemented in firmware, hardware, software, or a combination thereof. Event capture system 130 may provide a platform or an interface (e.g., an application programming interface) for an application to invoke event capture system 130 or for event capture system 130 to monitor operations performed by a user device. In some embodiments, event capture system 130 may be an application (e.g., a capture agent) residing on a user device. Event capture system 130 may be implemented using code or instructions (e.g., JavaScript) embedded in an application.

An application for which views are to be captured may be implemented to include all or some instructions of event capture system 130. In such examples, event capture system 130 may be implemented for different types of devices and/or different types of platforms on devices. For example, event capture system 130 may be configured specific to a platform on a device so as to utilize specific functions of the platform to capture views in an application. In one example, an application may be configured to have instructions that are invoked in different scenarios to call event capture system 130. The application may include a capture management platform to invoke event capture system 130. In another example, the capture management platform may be embedded in the application. In some embodiments, the application may be implemented with instructions that invoke event capture system 130 through a platform or interface provided by event capture system 130. For example, different functions for generating views in an application may be configured to call event capture system 130. Event capture system 130 may monitor a view based on the call from the application, and then event capture system 130 may perform or invoke the original function(s) that were initially called by the application.

Event capture system 130 may monitor interactions with an application or content in the application to determine a change in the view. For example, event capture system 130 may determine when an interactive element (e.g., a field) changes and/or when a new view (e.g., an interface) or the existing view is presented. Event capture system 130 may also determine events associated with presenting a view in the application. The events may be determined using a model associated with displaying content, e.g., a document, in the application. The events may be identified by a node or other information in the model associated with the view. Examples of events include, without restriction, an interaction with the application or a change in a document displayed in the application.

Event capture system 130 may be implemented in different ways to capture the view in an application. Event capture system 130 may monitor a view to determine an organization of the view. The view may be monitored according to a variety of techniques disclosed herein. The view may be monitored to determine any changes in the view. The view may be monitored to determine the view, such as a view hierarchy of the view in the application, a layout of the view, a structure of the view, one or more display attributes of the view, content of the view, lines in the view, or layer attributes in the view. Monitoring a view may include determining whether the view is created, loaded, rendered, modified, deleted, updated, and/or removed. Monitoring a view may include determining whether one or more views (e.g., windows) are added to the view.

Event capture system 130 may generate data that defines a view presented by an application. Event capture system 130 may generate the view as a layout or page representation of the view. Data may describe or indicate the view. The data may be generated in a format (e.g., HTML) that is different from a format in which the view in the application is written. For example, for multiple applications that are similar, but configured for different native environments, the view from each of the applications may be translated by event capture system 130 into data having a single format, e.g., HTML. The language may have a format that is different from a format of the language in which the view is generated in the application. The language may be generic or commonly used such that a computer system can process the data without a dependency on a particular language. Based on the information determined from monitoring a view at a user device, event capture system 130 may generate the data having a structure and the content according to the structure as it was displayed at the user device. For example, the data may be generated in HTML and may have a structure (e.g., a layout and/or an order) as to how content was seen in a view, such as headers, titles, bodies of content, etc. In some embodiments that data may be generated in the form of an electronic document for one or more views. The data may be generated to include attributes defining the view such as display attributes of the content. The data may be generated to include the content that was visibly seen in the view according to the structure of the view. In some embodiments, data may be generated for each distinct view identified in the application.

### B. Captured Data

The event capture system 130 can collect and output the captured data 148, e.g., the data points. The captured data 148 may include a list of user actions during the web session and/or interactions with one or more webpages of the web session. The captured data 148 can be unstructured data, structured data, or a combination of both.

Generally, the unstructured data is different from the structured data. For example, the structured data is highly specific and is stored in a predefined format. In an embodiment, the data points of the structured data are stored in a document format or a row/column format.

The unstructured data is a compilation of many varied types of data that are stored in their native formats. Unstructured data is the information that does not organize in a predictable or consistent way. It may be stored in images, videos, text documents, or other formats. Unstructured data can often be subjective information, as for example, a customer's opinion of their shopping experience or why they visited an online website. In an embodiment, the unstructured data is JSON formatted list of user actions during the web session and/or interactions with one or more webpages of the web session. Examples of the user interactions include URL of a webpage, a webpage title, webpage metadata (e.g., tags embedded for the purpose of search engine optimization), performance data (e.g., webpage and/or API load times), an identifier to a packet of data that shows what the webpage looked like when it first showed up, every individual action occurring on the webpage, a user image, etc. Actions occurring on the webpage may include small visual changes, e.g., “mutations,” such as a drop down menu, a pop up prompt, a dialogue, actions corresponding to the user performing a scroll, movements of the mouse, clicks on the mouse, user-input text, user-uttered voice command, etc.

### II. Generative AI System

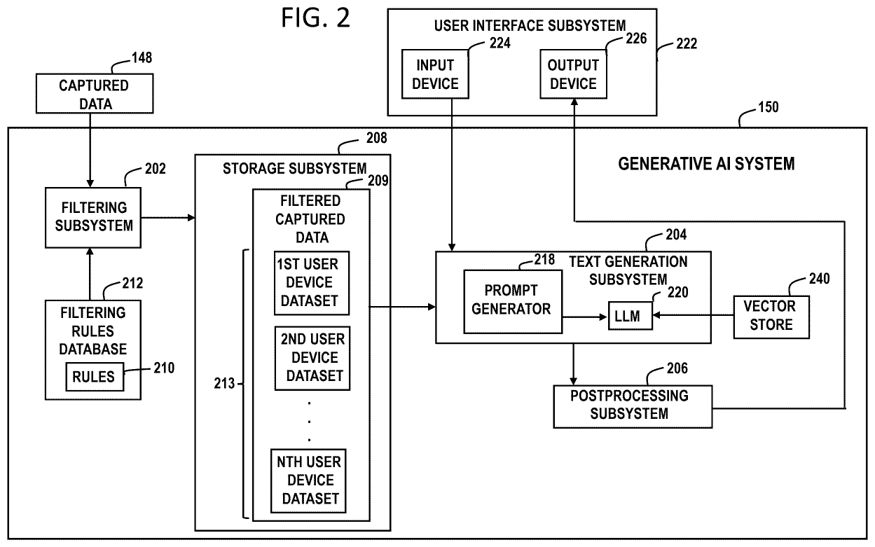

FIG. 2 is a simplified block diagram of a generative AI system 150 according to certain embodiments. The generative AI system 150 may be implemented using one or more computer systems, each computer system having one or more processors. The generative AI system 150 may include multiple components and subsystems communicatively coupled to each other via one or more communication mechanisms. For example, in the embodiment shown in FIG. 2, the generative AI system 150 includes a filtering subsystem 202, a text generation subsystem 204, and a postprocessing subsystem 206. These subsystems may be implemented as one or more computer systems. The systems, subsystems, and other components shown in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The generative AI system 150 shown in FIG. 2 is merely an example and is not intended to unduly limit the scope of embodiments. Many variations, alternatives, and modifications are possible. For example, in some implementations, generative AI system 150 may have more or fewer subsystems or components than those shown in FIG. 2, may combine two or more subsystems, or may have a different configuration or arrangement of subsystems. The generative AI system 150 and subsystems shown in FIG. 2 may be implemented using one or more computer systems, such as the computer system shown in FIG. 15.

As shown in FIG. 2, the generative AI system 150 also includes a storage subsystem 208 that may store the various data constructs and programs used by the generative AI system 150. For example, the storage subsystem 208 may store filtered captured data 209 that is used for generation of the text by the text generation subsystem 204, as described below.

### A. Filtering Subsystem

As described above, the generative AI system 150 may include the filtering subsystem 202. In general, the LLM context window (e.g., a textual range around a target token that the LLM can process at the time the information is generated) is limited in size, so that the data that is sent to the LLM might need to be condensed to the pieces that are most likely to produce valuable summarization. Further, while certain data points can offer valuable detail for full session replay playback, they could also influence the LLM to summarize intent, friction or outcome in a misleading or wrong way. For example, a failing API call to a third-party logging framework is unlikely to cause any user friction, but multiple failures could cause the LLM to name that API as the cause for failed task completion.

Accordingly, the filtering subsystem 202 accesses or receives the captured data 148 and filters the captured data 148 based on a filtering criteria, e.g., rules 210. For example, the rules 210 may be stored in a filtering rules database 212. Accordingly, the filtering subsystem 202 retrieves the rules 210 from the filtering rules database 212, applies the rules 210 to the captured data 148, and outputs the filtered captured data 209 to be provided to the text generation subsystem 204.

The filtering of the captured data (e.g., filtering criteria) is described in more detail below.

As mentioned above, the storage subsystem 208 may store the filtered captured data 209 that is used for generation of the text by the text generation subsystem 204. However, this is not intended to be limiting. In alternative implementations, the filtered captured data 209 may be stored in other memory storage locations (e.g., different databases) that are accessible to the generative AI system 150, where these memory storage locations can be local to or remote from the generative AI system 150.

In some embodiments, the filtered captured data 209 may be arranged as datasets 213, where each of the datasets 213 respectively corresponds to the first user device 110 and the second user device 112 to the Nth user device 114. For example, each of the datasets 213 may be identified by a user device identifier respectively associated with each of the first user device 110 and the second user device 112 to the Nth user device 114. Within each of the datasets 213, e.g., the first user device dataset, the collected captured data may be arranged by a webpage. For example, captured data associated with each webpage may be associated with a webpage identifier.

### B. Generating Summaries of Web Sessions Using LLM

In certain implementations, the text generation subsystem 204 includes a prompt generator 218 and a language model, e.g., a large language model (LLM) 220. The prompt generator 218 is configured to receive, as an input, a request for generating a summary. The prompt generator 218 processes the request and generates a prompt for the LLM 220.

Based on the questions being asked in the request for generating the summary, and the specific business served by the monitored application (for example, ecommerce versus travel versus banking), the prompt generator 216 can create a prompt that, as non-limiting examples, can:
Describe the purpose and mechanism of the captured data;
Summarize the structure of the captured data, what important fields within the data represent, etc.;
Specify industry-specific details of the data (for example, what a PNR confirmation number means to an airline application);
Lay out the questions that need to be answered in the resulting summary of the given captured data (for example: what was this user's intent for visiting the application, and did they complete their goal?);
Specify the desired summary output format (a length of response, a level of detail, etc.).

In an example depicted in FIG. 2, the prompt generator 218 receives the request for generating a summary from a user interface (UI) subsystem 222, e.g., via a user input received through an input device 224. As used herein, the user input provided via the UI subsystem 222 is received from a client or a technical personnel (e.g., an engineer, a technician, etc.). However, the described above is not intended to be limiting. In some implementations, the request for generating a summary may be generated by the generative AI system 150, e.g., when the network session data is received. Also, herein, the UI subsystem 222 can be referred to as a user interface.

The UI subsystem 222 may be implemented in an electronic device such as a computer, a mobile phone, etc. In some implementations, the UI subsystem 222 may be implemented in one or more of the first user device 110 to the Nth user device 114, or the UI subsystem 222 may be implemented in the electronic device different from any of the first user device 110 to the Nth user device 114. For convenience of description, the device, on which the UI subsystem 222 is implemented, is also herein referred to as a client device.

Although FIG. 2 illustrates only one input device 224, the UI subsystem 222 may include a plurality of input devices. The plurality of input devices may take any suitable form, e.g., buttons, keyboard, mouse, etc. The UI subsystem 222 may further include an output device 226 that may be a display screen. In some instances, the output device 226 may be a touch screen including a display screen for providing a display output and a touch pad serving as the input device 224.

The LLM 220 is configured to receive, as an input, the filtered captured data 209 output by the filtering subsystem 202 and the prompt. Using the filtered captured data 209, the LLM 220 generates natural language utterances according to the prompt and outputs the generated natural language utterances as a printed text or a voice. Herein, the natural language utterances output by the LLM 220 are referred to as the text or the summary.

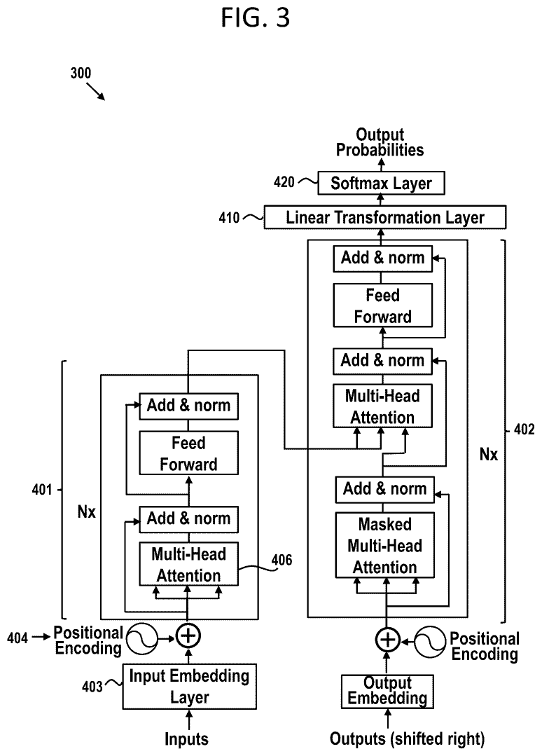

The LLM 220 may have an architecture of a transformer model. Examples of the LLM include T5, Llama, Palm, GPT-4, Gemini, Falcon, etc. As an example of a base LLM, the transformer model T5 is described below with reference to FIG. 3.

### 1. Example of LLM

FIG. 3 shows an exemplary architecture of T5 model 300, according to some embodiments.

T5 model is a pretrained language model that uses a unified “text-to-text” format for all text based NLP problems. The architecture of the T5 model is designed to support any Natural Language Processing task, e.g., classification, named entity recognition (NER), question answering, etc. The example of the tasks performed by T5 are generative tasks (such as machine translation, summarization, text generation) where the task format requires the model to generate text conditioned on some input, and classification tasks where T5 model is trained to output the literal text of the label (e.g., “positive” or “negative” for sentiment analysis).

T5 model uses a basic encoder-decoder transformer architecture. T5 model is pretrained on a masked language modeling “span-corruption” objective, where consecutive spans of input tokens are replaced with a mask token and the model is trained to reconstruct the masked-out tokens. The pretrained model sizes are from 60 million to 11 billion parameters. These models are pretrained on around 1 trillion tokens of data. Unlabeled data comes from the C4 dataset, which is a collection of about 750 GB of English-language text sourced from the public Common Crawl web scrape. C4 includes heuristics to extract only natural language (as opposed to boilerplate and other gibberish) in addition to extensive deduplication.

The T5 model 300 includes an encoder part 401 and a decoder part 402, as the components of a transformer model. First, an input sentence is tokenized into distinct elements, e.g., tokens. These tokens are typically integer indices in a vocabulary dataset. To feed those tokens into the neural network, each token is converted into an embedding vector by an input embedding layer 403. Further, a positional encoding layer 404, e.g., a linear encoding layer, is provided and injects positional encoding into each embedding so that the model can know word positions without recurrence. The outputs of the input embedding layer 403 and the positional encoding layer 404 are combined and passed on to a multi-head attention layer 406 of the encoder part 401. Thus, an input to the transformer is not the characters of the input text but a sequence of embedding vectors. Each vector represents the semantics and position of a token.

The output of the encoder part 401 is provided as an input to the decoder part 402 that generates an output sequence, e.g., an output vector. Then, the output vector from the decoder part 402 goes through a linear transformation layer 410 that changes the dimension of the vector from the embedding vector size into the size of vocabulary. The softmax layer 420 further converts the vector into probabilities that are then provided as an output of the T5 model 300. E.g., an output of the T5 model 300 are probabilities associated with the words distributed within the English language.

### 2. Outputting Summaries

As described above, the LLM 220 receives, as an input, the filtered captured data 209 and the prompt, and generates a summary of the filtered captured data 209 based on the prompt. The LLM 220 may output the summary to the UI subsystem 222. As an example, the LLM 220 may output a series of summaries for each webpage corresponding to the captured data. As another example, the LLM 220 may output a summary for an entire web session with regard to a particular user device.

The filtered captured data 209 includes events, e.g., event data, and timestamps corresponding to each event. The event data, which is passed on the prompt, have timestamps for each event. The LLM 220, based on the prompt, may associate each relevant timestamp for each event data that generated a given portion of the summary. The timestamps within the summary are parsed, turned into links, and removed from the summary, e.g., the timestamps do not show in the text of the summary although the timestamps are interleaved with the respective portions of the summary via links.

The LLM 220 is configured to output summaries having certain attributes. In some embodiments, the attributes may include intent, friction, and outcome.

The intent relates to the action(s) inferred by the LLM 220 from the user interaction(s) with one or more webpages. For example, the LLM 220 may analyze the input data points and generate the intent summary, e.g., inference of what the user was doing or intended to do, e.g., look for or buy a product, upgrade to a smartphone, pay a bill, sign up for a checking account on a banking website, etc. The example of the text summarizing the intent of the user shopping for the body suits may be: “I see you've been actively shopping with us, and you're quite interested in our body suits.”

The friction relates to issues encountered by the user that prevented them from competing intended action, e.g., a checkout. As an example, if the user expresses a frustration or cannot proceed to the next webpage, the LLM 220 analyzes this information and determines that the web session experienced a frustrating event, e.g., a friction. However, this is not intended to be limiting. In some cases, where the LLM 220 determines a conversion from the information displayed on the screen and/or infers no friction, the attribute “friction” is not included in the summary.

The outcome indicates whether the user completed the action, e.g., completed the checkout.

In an embodiment, the filtering subsystem 202 filters the captured data 148 to retain only highly-relevant events that may be identified by a filtering criteria in the rules 210, e.g., to obtain a set of events.

However, the filtering described above is not intended to be limiting. The rules 210 may be set, to include in the set of events, not relevant events, less relevant events, or all available events.

As example, for summarization of the user intent, the highly-relevant events indicating intent may include without limitation:
Page titles, e.g., the title of a given webpage or native application when loaded in that application or on the Internet.
Page meta descriptions that are used by the search engines but also within the browser to describe what a page does, so that an application developer can add those descriptions to signify that this is a product page that lists product details, search page that allows to find a product, etc.
Page URLs (e.g., the address of a page on the Internet).
User search phrases that relate to the things that a user types in to search for a given product (e.g., flight destination).
Navigation ordering (e.g., an order in which the pages were visited in a session). For example, the user can go to (1) a product search page, (2) a product detail page, (3) a specific product page, etc.
Referring URLs, e.g., the places that a user comes from when they start their web session. For example, if the user was on Facebook and then came to Home Depot, the referring URL is the URL of Facebook.
Referring inbound channels. This refers to a type of a channel that funneled the user to a particular website, e.g., a particular search engine or a social network. The referring inbound channel is similar to referring URL, but the information about the referring inbound channel includes information about the type of the channel versus a specific URL.
Referring inbound campaigns. This refers to the information about a particular campaign, e.g., “back to school.” This information is available on a URL that refers the user to a website.
Promotional offers activated. Information about promotional offers activated is information about the user activating a certain promo code and a type of promotional offer.
Specific product products and/or offers that the user engaged with (e.g., a checking account on a financial institution website, a one-way round-trip flight, a hotel room, a piece of clothing, etc.).

For summarization of the friction, the highly-relevant events indicating friction may include without limitation:
Frustration indicators that may include, as non-limiting examples, rage clicks, page reloads, heavy scrolling (e.g., scrolling page erratically instead of moving smoothly from one place to another), erratic mouse movement, negative emotion detected from an image or a voice, etc.
Technical errors detected (e.g., slow loading pages or API calls, API call failures, etc.).
Information from a survey, if any.
Information related to user contacting the customer support or “contact us” page.

The outcome depends on the user intent. Thus, the events above for the user intent are highly-relevant events for the summarization of the outcome. The highly-relevant events indicating outcome may also include without limitation:
The information indicating whether the goal of the intent is accomplished. For example, if the user was trying to sign up for a checking account, but this was not accomplished or the user signed up for another product that they did not have the intent to sign up for, this will indicate that the intended outcome was not accomplished.
Information about monetary conversion.
Information about conversion to the final stage (e.g., a checkout webpage).
Information about/from reaching out to customer support or “contact us” page.
Information from a survey (if any).
A time period of the session (e.g., if less than a predetermined time period, than the goal of the intent was not accomplished).

In certain implementations, the LLM 220 is further configured to generate a prediction for one or more next sentences based on one or more of the intent, friction and outcome. As used herein, for simplicity of description, the prediction for one or more next sentences may be referred to as “next paragraph prediction” and is one of the attributes of the summary output by the LLM 220. As an example, when the LLM 220 determines that the checkout is not completed, the LLM 220 may generate the next paragraph prediction. The next paragraph prediction is a text predicted by the LLM 220 that logically follows the preceding sentences of the summary. In some embodiments, the next paragraph prediction may provide a resolution for the friction inferred by the LLM 220.

In some embodiments, the LLM 220 may be configured to identify one or more blockers that prevented the user from accomplishing the user intent. For example, the LLM 220 may be configured to identify a most significant blocker among the one or more blockers, e.g., a blocker that most likely contributed in the greatest degree to the user intent not being accomplished. The LLM 220 can output the event name of the blocker, the event value, and a blocker timestamp. The blocker timestamp can be used to show the blocking experience in the replay playback on the UI subsystem 222, so that the client can have a visual representation of the blocking experience of the user.

An example of the summary and the information about the blocker can be generated as follows:
Example:

```
{
  summary: “The user was attempting to purchase a flight from SFO to
NYC on 2/28/2024. The user found their desired flight and selected seats,
but was unable to purchase the flight due to payment processing errors.
The most significant blocker was an API 500 error on /payment that
occurred 10 min into the session.”,
  blocker: “API 500 Error”,
  blocker_value: “/payment”,
  blocker_TS: 600
}
```

If the indication of the blocker is present in the returned textual description of the network session, the UI subsystem 222 may display a pop-up, e.g., a “Quantify” button for the client to assess how many other users are experiencing the same blocker. The “Quantify” button creates a “user segment” or “cohort” of users who experienced the same blocker/blocker_value combination and allows the client to see the size of the cohort, trend the size of cohort in charts over time, analyze lost revenue from the cohort, etc.

### 3. Examples of Summaries

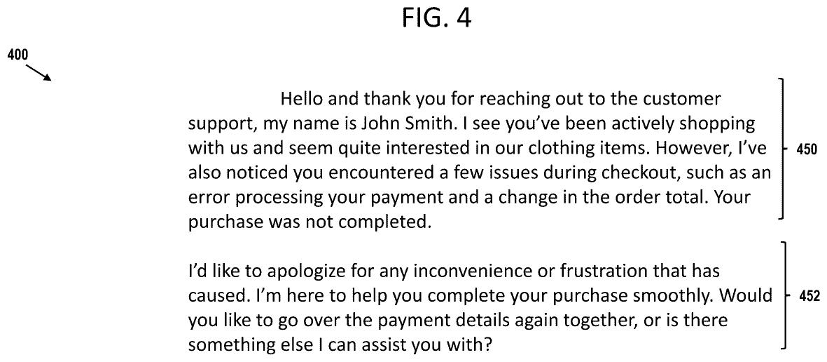

FIG. 4 illustrates an example of a summary 400 having attributes of the intent, friction, and next paragraph prediction. An example of the captured data that corresponds to the summary 400 is shown below.

```
<session>
  <page url=“https://quinnandmurray.com” title=“Quinn and
Murray”>
    <events>
      <event type=“pageview” />
      <event type=“click” value=“Men's” location=“/mens” />
    </events>
  </page>
  <page url=“https://quinnandmurray.com/mens” title=“Quinn and
Murray - Men”>
    <events>
      <event type=“pageview” />
      <event type=“click” value=“Clothing” location=“/clothing”
/>
    </events>
  </page>
  <page url=“https://quinnandmurray.com/clothing” title=“Quinn
and Murray - Clothing”>
    <events>
      <event type=“pageview” />
      <event type=“click” value=“Jeans” location=“/jeans” />
    </events>
  </page>
    <page url=“https://quinnandmurray.com/jeans” title=“Quinn
and Murray - Jeans”>
    <events>
      <event type=“pageview” />
      <event type=“click” value=“Slim Fit Jeans”
location=“/jeans/slim-fit” />
    </events>
  </page>
  <page url=“https://quinnandmurray.com/jeans/slim-fit”
title=“Quinn and Murray - Slim Fit Jeans”>
    <events>
      <event type=“pageview” />
      <event type=“click” value=“Add to Cart” />
    </events>
  </page>
  <page url=“https://quinnandmurray.com/cart” title=“Quinn and
Murray - Cart”>
    <events>
      <event type=“pageview” />
      <event type=“click” value=“Checkout” location=“/checkout”
/> </events>
  </page>
  <page url=“https://quinnandmurray.com/checkout” title=“Quinn
and Murray - Checkout”>
    <events>
      <event type=“pageview” />
      <event type=“form_submit” value=“Place Order” />
      <event type=“error” value=“Payment Declined” />
      <event type=“change” field=“order_total” value=“$150 ->
$165” />
    </events>
  </page>
</session>
```

The summary 400 of FIG. 4 may be output on the user device of the user via a chatbot, e.g., via a text or a voice. For example, a method of the output may be provided by the request for the summary and then converted, by the prompt generator 218, to be included within the prompt.

The content of the summaries may be generated differently based on a plurality of purpose levels. In an embodiment, the purpose level may be included in the request for the summary and, accordingly, in the prompt.

In an example, the plurality of purpose levels may include a first purpose level corresponding to a simple summary, e.g., a support agent summary, and a second purpose level corresponding to a detailed summary, e.g., a manager summary (e.g., a multi-point summarization where someone who works on the web/native application could get a more detailed readout of data points related to the session). The LLM 220 may receive an input of a respective purpose level and generate the summary according to the requested purpose level.

In FIG. 4, the summary 400 is generated and output according to the first purpose level as the support agent summary. The first paragraph 450 of the summary 400 describes the intent, friction, and outcome. The second paragraph 452 of the summary 400 is a next paragraph prediction that is generated by the LLM 220 based on the intent, friction, and outcome. For example, the next paragraph prediction can propose a resolution for the friction.

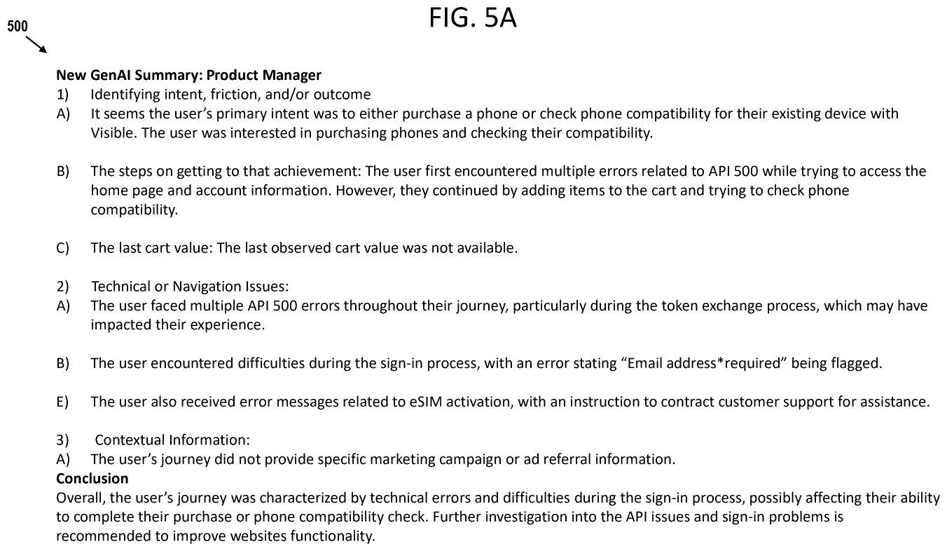

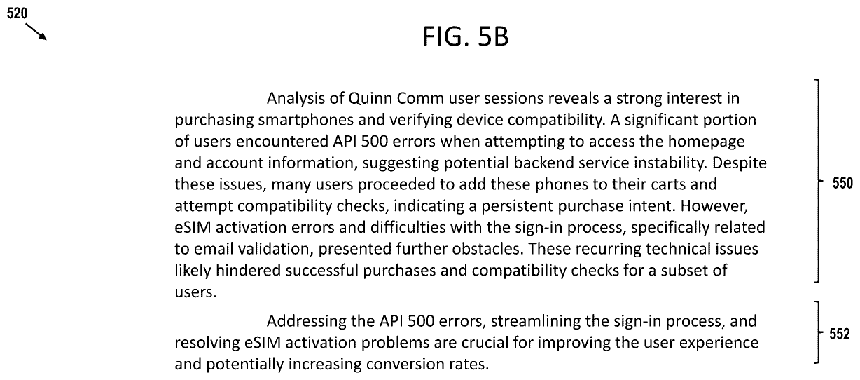

FIG. 5 shows an example of a summary 500 generated and output according to the second purpose level as the manager summary that represents the events happening throughout the entire web session. An example of the captured data that corresponds to the summary 500 is shown below.

```
<session>
  <page url=“https://www.quinnwireless.com” title=“Quinn Comm -
Homepage”>
    <events>
      <event type=“pageview” />
      <event type=“error” value=“API 500 - Internal Server
Error” api_url=“https://api.quinnwireless.com/home” />
    </events>
  </page>
  <page url=“https://www.quinnwireless.com/account” title=“Quinn
Comm - Account”>
    <events>
      <event type=“pageview” />
      <event type=“error” value=“API 500 - Service Unavailable”
api_url=“https://api.quinnwireless.com/account” />
    </events>
  </page>
    <page url=“https://www.quinnwireless.com/smartphone-25”
title=“Quinn Comm - smartphone 25”>
    <events>
      <event type=“pageview” />
      <event type=“add_to_cart” product_id=“smartphone25-128gb”
/> </events>
  </page>
  <page url=“https://www.quinnwireless.com/cart” title=“Quinn
Comm - Cart”>
    <events>
      <event type=“pageview” />
    </events>
  </page>
  <page url=“https://www.quinnwireless.com/compatibility”
title=“Quinn Comm - Compatibility Check”>
    <events>
      <event type=“pageview” />
      <event type=“check_compatibility” />
      <event type=“error” value=“eSIM Activation Error - Contact
Support” />
    </events>
  </page>
  <page url=“https://www.quinnwireless.com/login” title=“Quinn
Comm - Sign In”>
    <events>
      <event type=“pageview” />
      <event type=“form_error” field=“email” value=“Email
address required” />
    </events>
  </page>
</session>
```

The LLM 220 generates the summary 500 by analyzing the web session, webpage by webpage, and summarizing the events.

In the summary 500, the first section (indicated by a numeral 1) identifies three attributes:
A—Intent
B—Friction
C—Outcome

Further, the summary 500 includes a second section (indicated by a numeral 2) that is an expanded description of the friction, e.g., of section (1)(B). The expanded description of friction identifies technical and/or navigation issues encountered by the user as a result of the user's interactions with one or more webpages during the web session.

A third section of the summary 500 (indicated by a numeral 3) provides a contextual information relating to the circumstances surrounding the given web session.

The conclusion section provides a summary of the user's interaction with the website that led to the outcome of the web session, e.g., incompletion of the action intended by the user. The conclusion also includes a next paragraph prediction that is generated by the LLM 220 based on the intent, friction, and outcome, and proposes a resolution for the friction.

In certain implementations, the LLM 220 may generate and output the summary according to the third purpose level for a plurality of users, e.g., an aggregate summary that is a summarization of block of events that correspond to a plurality of users. An example of the aggregate summary 520 is shown in FIG. 5B.

The first paragraph 550 of the aggregate summary 520 describes the intent, friction, and outcome. The second paragraph 552 of the aggregate summary 520 is a next paragraph prediction that is generated by the LLM 220 based on the intent, friction, and outcome. For example, the next paragraph prediction can propose a resolution for the friction.

### III. Methods of Generating and Outputting a Summary

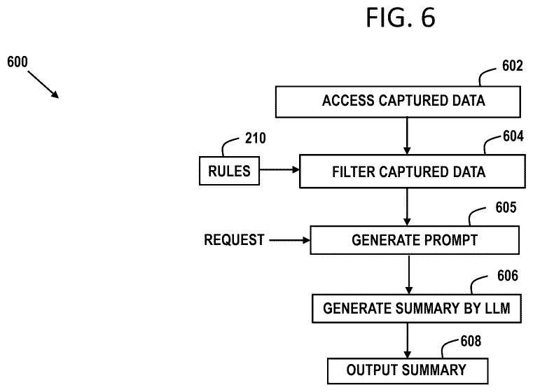

FIGS. 6 to 8 illustrate flowcharts of the processing performed by the generative AI system 150 in accordance with various embodiments.

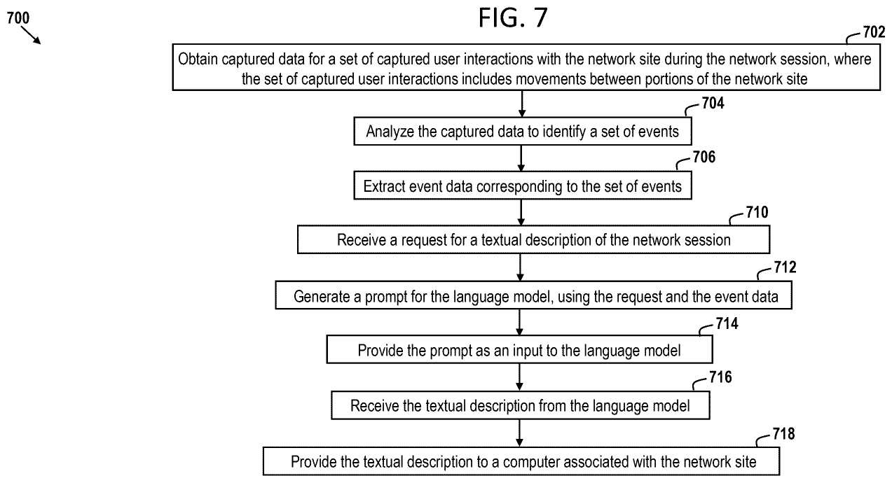

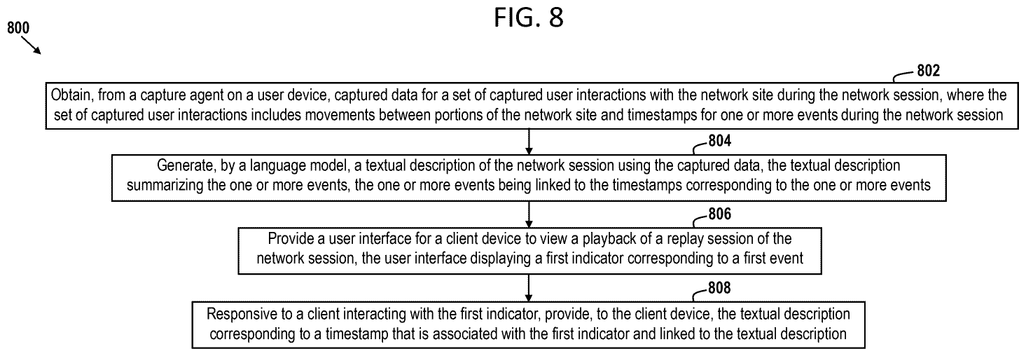

FIG. 6 shows an example of an overall method of the generative AI system 150 for generating and outputting a summary. FIG. 7 shows an example of a more detailed method of the generative AI system 150 for generating and outputting a summary. FIG. 8 shows an example of a method of the generative AI system 150 for generating a summary and providing a replay of the summary.

The processing of each of FIGS. 6 to 8 may be performed by some or all of the filtering subsystem 202, the text generation subsystem 204, and the postprocessing subsystem 206, and may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). Each of the methods presented in FIGS. 6 to 8 and described below is intended to be illustrative and non-limiting. Although each of FIGS. 6 to 8 depicts the various processing operations occurring in a particular sequence or order, this is not intended to be limiting. In certain alternative embodiments, the processing of each of FIGS. 6 to 8 may be performed in some different order or some operations may be performed at least partially in parallel.

FIG. 6 is a simplified block diagram of a processing 600 performed by the generative AI system 150 in accordance with various embodiments.

Referring to FIG. 6, at operation 602, the filtering subsystem 202 may access the captured data.

At operation 604, the filtering subsystem 202 may filter the captured data based on the rules 210.

At operation 605, the prompt generator 218 may generate a prompt based on the request for a summary.

At operation 606, the LLM 220 may receive the filtered captured data and the prompt, perform certain processing on the filtered captured data, and generate the summary of the filtered captured data according to the prompt.

At operation 608, the postprocessing subsystem 206 may perform postprocessing on the summary and output the summary, e.g., to the UI subsystem 222 or to another external device via a network.

FIG. 7 is a more detailed block diagram of a processing 700 performed by the generative AI system 150 in accordance with various embodiments.

Referring to FIG. 7, at operation 702, the generative AI system 150 can obtain, from a capture agent on a user device, captured data for a set of captured user interactions with the network site during the network session, where the set of captured user interactions includes movements between portions of the network site.

The set of captured user interactions can further include data provided in one or more fields on the network site.

At operation 704, the generative AI system 150 can analyze the captured data to identify a set of events.

At operation 706, the generative AI system 150 can extract event data corresponding to the set of events. E.g., to obtain the set of events can include highly relevant events, not relevant events, less relevant events, or all available events, based on the rules.

In certain implementations, the generative AI system 150 can store the event data at a storage location accessible by a language model, e.g., the LLM 220.

At operation 710, the generative AI system 150 can receive a request for a textual description of the network session.

At operation 712, the generative AI system 150 can generate a prompt for the language model, using the request and the event data.

At operation 714, the generative AI system 150 can provide the prompt as an input to the language model.

At operation 716, the generative AI system 150 can receive the textual description from the language model.

The textual description can include an outcome indicating that a user intent with regard to the network session was not accomplished, and the method can further include identifying, by the language model, a most significant blocker that substantially contributed to the user intent not being accomplished; and providing, by the language model for the most significant blocker, information including an event name, an event value, and a blocker timestamp.

At operation 718, the generative AI system 150 can provide the textual description to a computer associated with the network site.

The set of captured user interactions with the network site during the network session can include interactions between the network site and a plurality of user devices operated by a plurality of users, and the method can further include providing a user interface for a client device to view a playback of a replay session of the network session; and responsive to a client input via the user interface, providing, to the client device, information related to a set of user devices that encountered the most significant blocker among the plurality of user devices.

The information related to the set of user devices can include information about a number of user devices included in the set of user devices.

The information related to the set of user devices can further include information about a change in the number of user devices over time.

FIG. 8 is a block diagram of a processing 800 performed by the generative AI system 150 for generating and replaying a summary in accordance with various embodiments.

Referring to FIG. 8, at operation 802, the generative AI system 150 can obtain, from a capture agent on a user device, captured data for a set of captured user interactions with the network site during the network session, where the set of captured user interactions includes (1) movements between portions of the network site and (2) timestamps for one or more events during the network session.

The set of captured user interactions may further include data provided in one or more fields on the network site.

At operation 804, the language model, e.g., the LLM 220 can generate a textual description of the network session using the captured data, the textual description summarizing the one or more events, the one or more events being linked to the timestamps corresponding to the one or more events.

At operation 806, the generative AI system 150 can provide a user interface for a client device to view a playback of a replay session of the network session, the user interface displaying a first indicator corresponding to a first event.

At operation 808, the generative AI system 150 can, responsive to a client interacting with the first indicator, providing, to the client device, the textual description corresponding to a timestamp that is associated with the first indicator and linked to the textual description.

The textual description includes an outcome indicating that a user intent with regard to the network session was not accomplished, and where the method may further include identifying, by the language model, a most significant blocker that substantially contributed to the user intent not being accomplished; and providing, by the language model for the most significant blocker, information including an event name, an event value, and a blocker timestamp.

The set of captured user interactions with the network site during the network session can include interactions between the network site and a plurality of user devices operated by a plurality of users, and the method can further include, responsive to a client input via the user interface, providing, to the client device, information related to a set of user devices that encountered the most significant blocker among the plurality of user devices.

The information related to the set of user devices includes information about a number of user devices included in the set of user devices.

The information related to the set of user devices further includes information about a change in the number of user devices over time.

In various embodiments, the method can further include overlaying the playback of the replay session with graphical representations corresponding to spans, where each of the spans corresponds to a logical grouping of events representing a topic during the network session; and responsive to the client interacting with one of the graphical representations, displaying a textual description that describes the topic occurring in a time period for the span corresponding to the one of the graphical representations.

### V. Aggregate Summaries

In embodiments, the LLM 220 may generate and output the summary for each web session of each of the plurality of users using a default prompt, thereby generating a set of summaries, e.g., hundreds or thousands of summaries. Then, an engineer can provide, as an input, a request to the LLM 220, which can mine the set of summaries to determine how to respond. For example, the engineer can provide request, based on which the prompt can be generated as: “give summary of shopping by users today”. The LLM 220 can then return, as an output, the aggregate summary describing what the users were shopping for (“intent”), technical difficulties encountered by the users (“friction”), and the outcome. For example, the outcome may be presented such as: “70% of intent/action is complete”).

In some implementations, based on the prompt, the LLM 220 may divide the events of the captured data into logical groupings of thematic user intent. The examples of the groupings include: “Creating an account”, “Signing in”, “Searching for clothing”, “Browsing women's yoga pants”, “Checking out”, etc. The LLM 220 may identify the first and last timestamps for events within each distinct group, and provide a concise text summary of the intent corresponding to the group. The timestamps can be used to overlay the session with spans, e.g., segments or sections, that describe what the user(s) were doing in each section.

In some implementations, the engineer can provide, as an input, a request to the LLM 220, which can sample the filtered captured data 209 and then generate an aggregate summary of the interactions with one or more websites by a plurality of users operating the first user device 110 to the Nth user device 114.

After reviewing the aggregate summary, the engineer may input another request to the LLM 220. The LLM 220 then can, based on a new prompt generated based on a new request, provide another summary according to the aggregate summary and the new prompt.

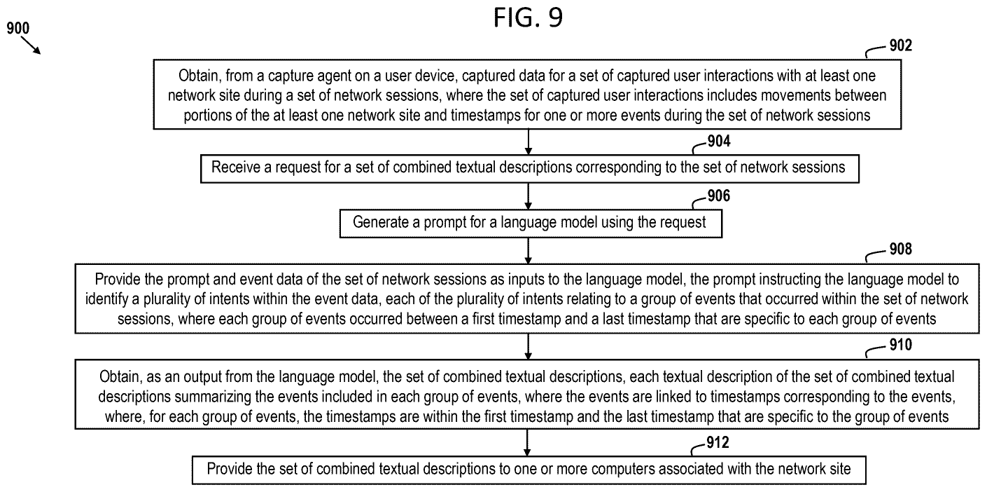

FIG. 9 is a block diagram of a processing 900 performed by the generative AI system 150 for generating and outputting an aggregate summary in accordance with various embodiments. The processing 900 may be performed by some or all of the filtering subsystem 202, the text generation subsystem 204, and the postprocessing subsystem 206. The processing 900 may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 9 and described below is intended to be illustrative and non-limiting. Although FIG. 9 depicts the various processing operations occurring in a particular sequence or order, this is not intended to be limiting. In certain alternative embodiments, the processing 900 may be performed in some different order or some operations may be performed at least partially in parallel.

Referring to FIG. 9, at operation 902, the generative AI system 150 can obtain, from a capture agent on a user device, captured data for a set of captured user interactions with at least one network site during a set of network sessions, where the set of captured user interactions includes (1) movements between portions of the at least one network site and (2) timestamps for one or more events during the set of network sessions.

At operation 904, the generative AI system 150 can receive a request for a set of combined textual descriptions corresponding to the set of network sessions.

At operation 906, the generative AI system 150 can generate a prompt for a language model (e.g., the LLM 220) using the request.

At operation 908, the generative AI system 150 can provide the prompt and event data of the set of network sessions as inputs to the language model, the prompt instructing the language model to identify a plurality of intents within the event data, each of the plurality of intents relating to a group of events that occurred within the set of network sessions, where each group of events occurred between a first timestamp and a last timestamp that are specific to each group of events.

At operation 910, the generative AI system 150 can obtain, as an output from the language model, the set of combined textual descriptions, each textual description of the set of combined textual descriptions summarizing the events included in each group of events, where the events are linked to timestamps corresponding to the events, where, for each group of events, the timestamps are within the first timestamp and the last timestamp that are specific to the group of events.

At operation 912, the generative AI system 150 can provide the set of combined textual descriptions to one or more computers associated with the network site.

The method may further include providing a user interface for a client device to view a playback of a replay session of the network session; responsive to a client interacting with the user interface, providing, to the client device, a plurality of textual descriptions from the set of combined textual descriptions; and displaying, on the user interface, the plurality of textual descriptions in correspondence to the timestamps.

In various embodiments, the displaying may include overlaying the playback of the replay session with spans, where each of the spans corresponds to one of the plurality of textual descriptions and describes events occurring in a time period corresponding to each of the spans.

### VI. Generating a Summary of Summaries

In some embodiments, the generative AI system 150 may generate a summary of summaries. For example, the event capture system 130 may, for each network session of the set of network sessions, obtain, from a capture agent on a user device (e.g., at least one among the first user device 110 to the Nth user device 114), captured data (e.g., at least a portion of the captured data 148) for a set of captured user interactions with the network site during the network session. The set of captured user interactions includes movements between portions of the network site.

As described above, the LLM 220 may generate a session-specific textual description of the network session using the captured data, thereby generating a set of session-specific textual descriptions.

The generative AI system 150 may receive a request for a combined textual description of the set of network sessions. The prompt generator 218 may generate a prompt based on the received request and provide the prompt to the LLM 220.

The LLM 220 may also receive, as an input or inputs, the session-specific textual descriptions and generate the combined textual description, e.g., a summary of summaries, based on the prompt.

The combined textual description may be postprocessed by the postprocessing subsystem 206 and provided to a computer associated with the network site.

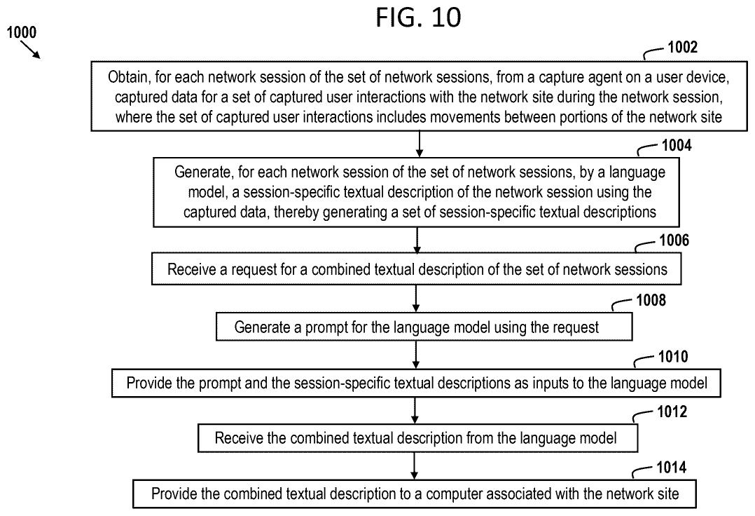

FIG. 10 is a block diagram of a processing 1000 performed by the generative AI system 150 for generating and outputting an aggregate summary in accordance with various embodiments. The processing 1000 may be performed by some or all of the filtering subsystem 202, the text generation subsystem 204, and the postprocessing subsystem 206. The processing 1000 may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 10 and described below is intended to be illustrative and non-limiting. Although FIG. 10 depicts the various processing operations occurring in a particular sequence or order, this is not intended to be limiting. In certain alternative embodiments, the processing 1000 may be performed in some different order or some operations may be performed at least partially in parallel.

Referring to FIG. 10, at operation 1002, the generative AI system 150 can, for each network session of the set of network sessions, obtain, from a capture agent on a user device, captured data for a set of captured user interactions with the network site during the network session, where the set of captured user interactions includes movements between portions of the network site.

At operation 1004, the language model (e.g., the LLM 220) can, for each network session of the set of network sessions, generate a session-specific textual description of the network session using the captured data, thereby generating a set of session-specific textual descriptions.

At operation 1006, the generative AI system 150 can receive a request for a combined textual description of the set of network sessions.

At operation 1008, the generative AI system 150 can generate a prompt for the language model using the request.

At operation 1010, the generative AI system 150 can provide the prompt and the session-specific textual descriptions as inputs to the language model.

At operation 1012, the generative AI system 150 can receive the combined textual description from the language model.

At operation 1014, the generative AI system 150 can provide the combined textual description to a computer associated with the network site.

### VII. Implementation of LLM

In some embodiments, the text generation subsystem 204 implements a base LLM (not shown). As used herein, the base LLM means an off-the-shelf LLM, e.g., T5, Llama, Palm, GPT-4, Gemini, Falcon, etc.

In certain implementations, the base LLM is trained or enhanced, to generate the LLM 220. For example, the base LLM may be trained using training samples of the session data, human-curated summaries, and corresponding prompts. In addition to training, the generative AI system 150 may implement prompt engineering and/or augmented response generation.

However, the described-above is not intended to be limiting. In certain implementations, an off-the-shelf large language model can be used.

### A. Prompt Engineering

As mentioned above, the generative AI system 150 may employ prompt engineering. Prompt engineering involves designing and testing various prompts to optimize the performance of the model in generating accurate and relevant responses. As an example, static details can be added to the prompt, instructing the LLM on how to respond. This can include, providing within the prompt, at least one of the expected output format, voice, tone, length of response, examples of good input/output pairs, etc.

For example, the prompt can be modified using the LLM 220 or other ML model to obtain an optimized prompt that can be then input into the LLM 220 with the session data to generate the desired output.

For example, the prompts may be created by industry or by customer.

### B. Retrieval-Augmented Generation

Retrieval-augmented generation (RAG) for LLMs aims to improve prediction quality by using an external data store at inference time to build a richer prompt that includes some combination of context, history, and recent/relevant knowledge.

In embodiments, the generative AI system 150 may use a separate store of context data, e.g., a vector database or a vector store 240. The given session data is compared to other session data payloads that generated highly accurate summaries. This comparison can be used to augment the prompt to be sent to the LLM 220, providing additional context that is most likely to improve the output accuracy. Example of prompt augmentation/additional context (e.g., RAG augmented context) is as follows.

```
Retrieved context from knowledge base
[
  {
    “title”: “Troubleshooting API 500 Errors”,
    “content”: “API 500 errors indicate a problem with our
    backend servers. Common causes include server
    overload, database issues, or code bugs. Users
    experiencing these errors may need to try again later
    or contact support.”
  },
  {
    “title”: “eSIM Activation Issues”,
    “content”: “eSIM activation can be complex. Errors can
    arise from incorrect device details, network problems,
    or issues with the eSIM profile. Users may need to
    contact support for assistance with eSIM activation.”
  },
  {
    “title”: “Email Validation Requirements”,
    “content”: “Our sign-in process requires a valid and
    properly formatted email address. Typos or inactive
    emails will be rejected.”
  }
]
```

This is similar to one of the aspects of the prompt engineering where the examples of the good summaries are provided within the prompt. However, in this instance, the context passed onto the prompt can differ with each requested summary, using examples that are most closely related to what was requested to be summarized. The data used for context can be modified on-the-fly, so the data can improve results over time, versus the static examples that are provided using prompt engineering.

There could be different vector stores for different clients or different sectors.

### C. Training Refining LLM

Alternatively or additionally to the prompt engineering and/or the RAG, in an embodiment, the base LLM can be specifically trained with the concepts described above for the prompt engineering and the RAG. This makes the LLM 220 become more specific to the fine-tuned use case. For example, the base LLM model can be fine-tuned using the examples of desirable inputs/outputs to understand that its job is to generate summaries of web/native application sessions. A prompt to a fine-tuned LLM would simply include less instructions explaining the structure of the provided data, because that would be trained into the model.

### VIII. User Interface Connecting Summaries and Replay Session

As described above, the summaries output by the LLM 220 are input to the postprocessing subsystem 206. The postprocessing subsystem 206 is configured to perform certain processing on the summaries and output summaries in a human-recognizable format, e.g., as a textual summary and/or as a playback of a replay session, on the UI subsystem 222 or another user interface accessible to the generative AI system 150.

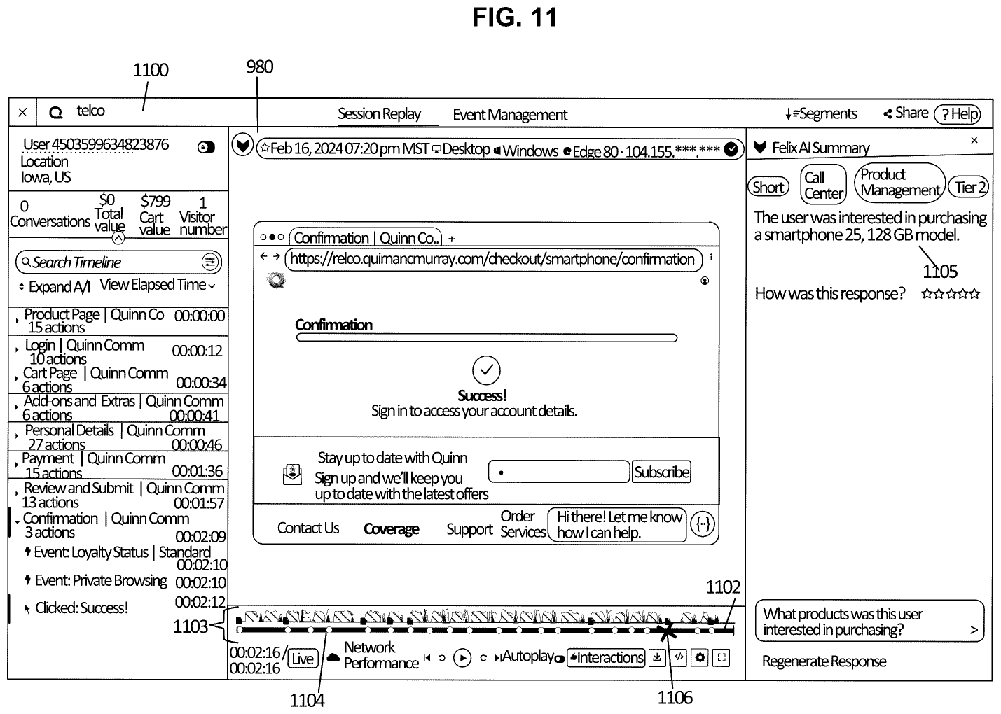

FIGS. 11 to 14 are simplified illustrations of a graphical user interface, in accordance with various embodiments.

With reference to FIG. 11, in some embodiments, the postprocessing subsystem 206 may output an interactive interface 980 on a user interface 1100, allowing engineer's manipulation to retrieve desired information. An area on a left-hand side of the user interface 1100 lists, for a web session, user interactions (e.g., events) detected for a user having a certain identifier.

The interactive interface 980 may have at least some functionalities of a video player. For example, the interactive interface 980 may display a timeline 1102 corresponding to the timestamps in the captured data as an interactive graph 1103. The captured data has time series markers 1104. In various embodiments, replay works by playing back from an original timestamp in real time (e.g., at original speed) or at 2×, 4×, etc., through the timestamped events. For example, the engineer may replay the web session maintaining the original speed at which the events happened.

For example, the timeline 1102 may have markers 1104 that correspond to at least some webpages visited by the user in the web session. By clicking on the marker 1104 corresponding to the webpage, the engineer can watch the replay of the interactions with the webpage and also read a summary 1105 of user interactions corresponding to the selected webpage. For example, a summary 1105 of user interactions corresponding to a certain webpage can be displayed in a pop up window visually connected to the marker or on a separate area of the screen of an interactive interface 1100. The graph 1103 can be displayed in the other area of the display screen.

If, for example, the user experienced a friction during the web session, the position of the graph 1103 corresponding to the problematic webpage may be additionally or alternatively marked with a specific character 1106, e.g., a red dot, cross-hair, etc. By clicking on the marker or the specific character corresponding to the problematic webpage, the engineer can watch the replay of the interactions with the problematic webpage and read a summary corresponding to the problematic webpage.

In some embodiments, the graph 1103 may be annotated to indicate that the user was trying to perform the same action, e.g., trying to log in from one time point to another time point.

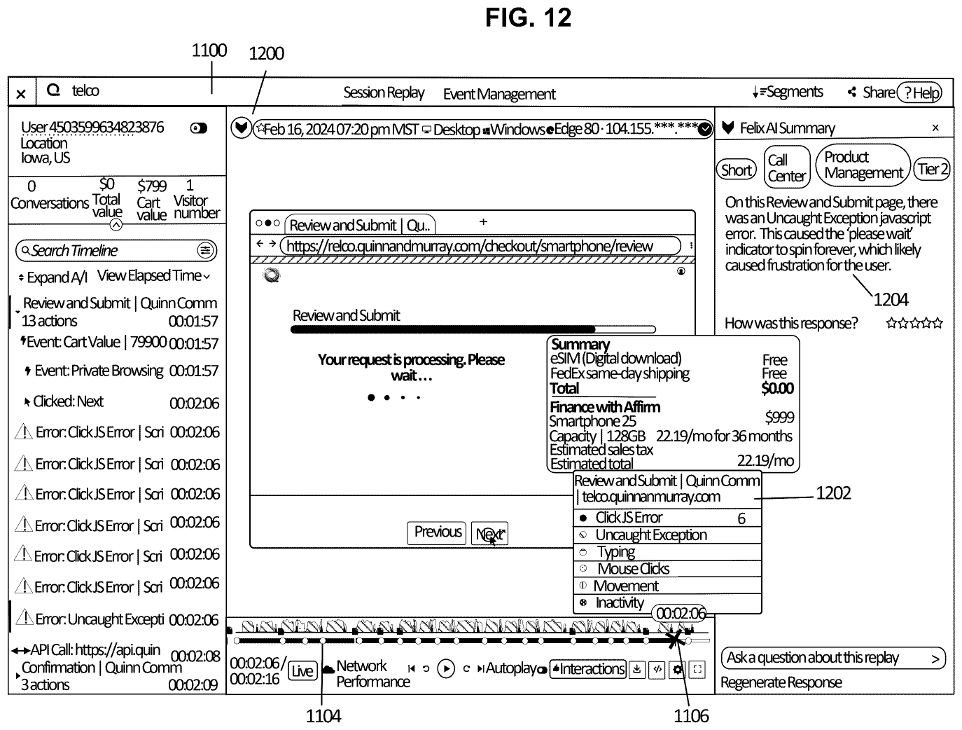

In certain implementations, the engineer can hover a mouse over a time point or the marker on the graph 1103 of an interactive interface 1200, and user interactions 1202 around this time point can be displayed, as shown in FIG. 12. A summary 1204 of user interactions around the selected time point can also be displayed in a pop up window visually connected to the marker or on a separate area of the screen of an interactive interface 1200, as shown in FIG. 12. The graph 1103 can be displayed in the other area of the display screen.

An area on the left-hand side of the user interface 1100 lists, for a web session, user interactions and the errors (e.g., events) detected for a user having a certain identifier.

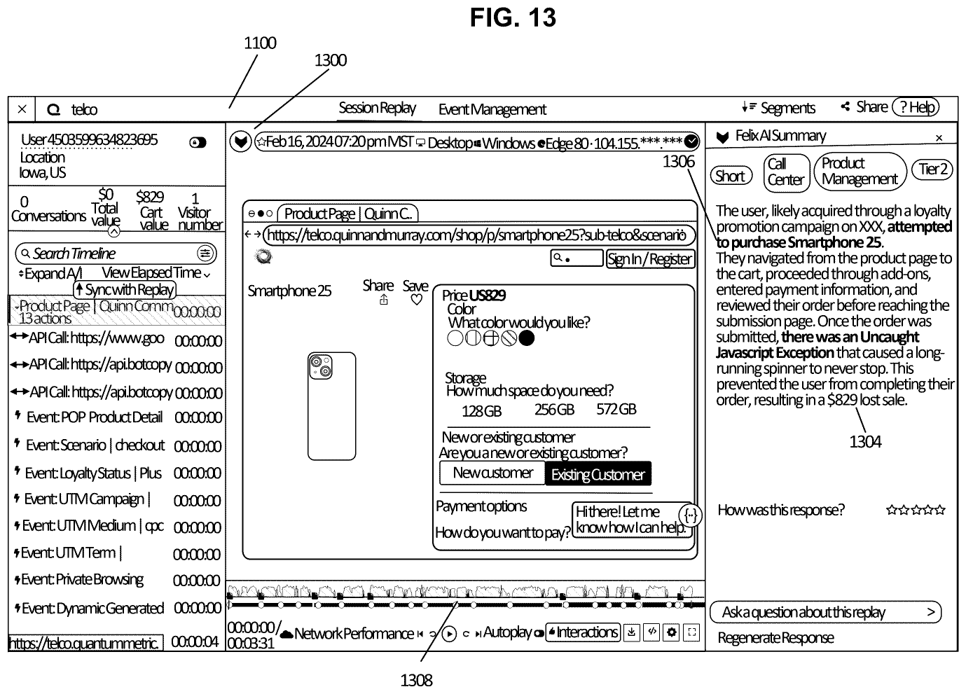

Referring to FIG. 13, as mentioned above, in various embodiments, the summary 1304 of the user interactions during the entire web session can be displayed on the replay session displayed on an interactive interface 1300. For example, the summary 1304 can include intent, friction, and outcome, and can be displayed as a pop-up window or in one area of the display screen. The engineer can click on one or more words (e.g., words in bold referenced by numeral 1306) in the summary 1304, e.g., on a sequence of words expressing intent. This action will connect to a certain time point on the graph, e.g., a time marker 1308. This action can initiate a replay of the web session at that time point.

In the disclosed techniques, the generated summary, e.g., the summary 1304, may be provided to an agent or a chatbot communicating with a customer. Since the summary already contains intent, friction, and outcome, the time spent fixing the website problem is substantially reduced. In some implementations, the LLM 220 may infer a resolution for the friction by predicting the next paragraph that logically follows the summary. The resolution for the friction may be provided to another machine, e.g., a chatbot.

In the disclosed techniques, the generated summary may be used to retarget individual customers who did not reach a desired goal within a digital experience. Rather than sending generic correspondence to recapture a customer, a context-aware summary can mention products that the customer browsed, friction that may have been encountered, offer promotional codes for specific items of interest, etc. This retargeting could also feed directly to the agent or chatbot communicating with a customer.

In the disclosed techniques, for explicit forms of customer feedback, such as “contact us forms” or customer surveys, the data may be provided to the generative AI system 150. The generative AI system 150 may summarize the content of the provided data and generate succinct, or neatly-categorized summarization of the customer input. This can be used both on individual feedback methods, such as single surveys, or in aggregate across a number of feedback entries to gain an understanding of overall customer feedback trends.

In the disclosed techniques, in addition to the summarization of contact/feedback content itself, the direct customer feedback may be paired with a summary of the session that generated that feedback. For example, if a customer left a survey response “This experience was so difficult”, next to the response, a short summary of the session may be provided.

In the disclosed techniques, based on the prompt, the LLM 220 may divide the events of the captured data into spans (e.g., time blocks) corresponding to logical groupings of thematic user intent, e.g., topics. The examples of the topics can include: “Creating an account”, “Signing in”, “Searching for clothing”, “Browsing women's yoga pants”, “Checking out”, etc. The LLM 220 may identify the first and last timestamps for the events within each span, and provide a text summary of the intent corresponding to the span. The timestamps can be used to overlay the session with spans, e.g., segments or sections, that describe what the user(s) were doing in each section.

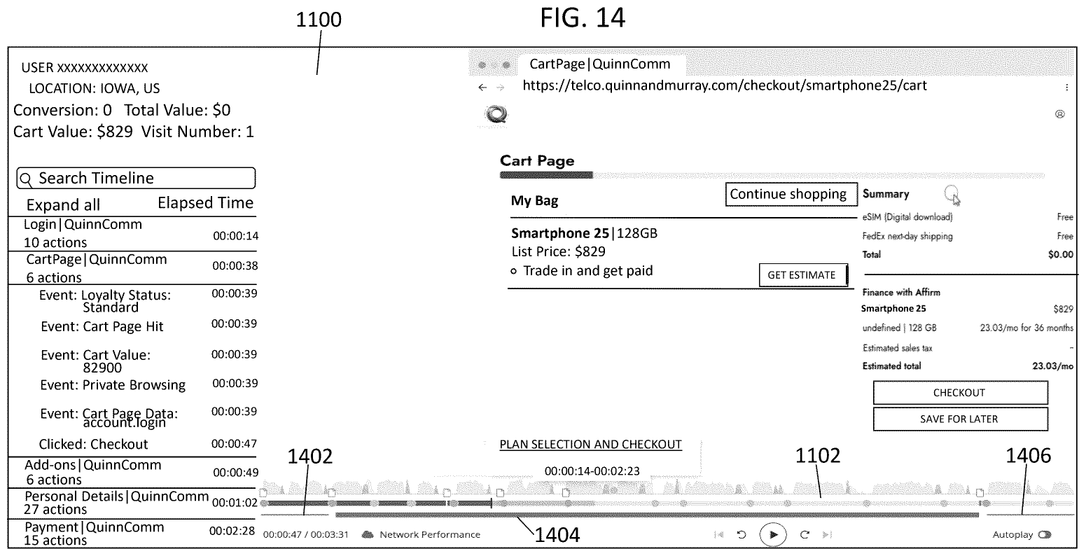

With reference to FIG. 14, the playback of the replay session can be overlaid with spans that are represented as bars 1402, 1404, 1406 (e.g., graphical representations) along a timeline 1102. Each span (e.g., a respective bar) corresponds to a time period between timestamps delineating each thematic segment. For example, the engineer can select the bar 1404, by clicking on the bar 1404 or hovering the mouse over the bar 1404. The LLM 220 may provide a concise text summary of the intent corresponding to the span as “Plan selection and checkout.” The time period for “Plan selection and checkout” is from 00:00:14 to 00:02:23, relative to the beginning of the session.

If the engineer selects one of the other bars (e.g., bar 1402 or bar 1406), the LLM 220 can provide a text summary of the intent corresponding to the span represented by the selected bar. If, for instance, the user were trying to perform the same action, e.g., trying to log in from one time point to another time point, and the engineer selects the bar 1402 corresponding to these time points, the LLM 220 may provide a text summary of the intent corresponding to the span as “Logging in.”

The described above is not intended to be limiting. For example, any number of spans can be identified on the timeline 1102, e.g., 2, 4, . . . , 10, and any textual appropriate description of the span can be provided.

In various embodiments, a system can be provided. The system includes one or more processors; and a non-transitory computer-readable medium memory coupled to the one or more processors, the non-transitory computer-readable medium memory storing instructions that, when executed by the one or more processors, cause the one or more processors to perform a method for generative artificial intelligence of user interactions with a network site during a network session, the method including: obtaining, from a capture agent on a user device, captured data for a set of captured user interactions with the network site during the network session, where the set of captured user interactions includes movements between portions of the network site; analyzing the captured data to identify a set of events; extracting event data corresponding to the set of events; receiving a request for a textual description of the network session; generating a prompt for the language model, using the request and the event data; providing the prompt as an input to a language model; receiving the textual description from the language model; and providing the textual description to a computer associated with the network site.

In various embodiments, a system can be provided. The system includes one or more processors; and a non-transitory computer-readable medium memory coupled to the one or more processors, the non-transitory computer-readable medium memory storing instructions that, when executed by the one or more processors, cause the one or more processors to perform a method for generative artificial intelligence of user interactions with a network site during a network session, the method including: obtaining, from a capture agent on a user device, captured data for a set of captured user interactions with the network site during the network session, where the set of captured user interactions includes (1) movements between portions of the network site and (2) timestamps for one or more events during the network session; generating, by a language model, a textual description of the network session using the captured data, the textual description summarizing the one or more events, the one or more events being linked to the timestamps corresponding to the one or more events; providing a user interface for a client device to view a playback of a replay session of the network session, the user interface displaying a first indicator corresponding to a first event; and responsive to a client interacting with the first indicator, providing, to the client device, the textual description corresponding to a timestamp that is associated with the first indicator and linked to the textual description.

In various embodiments, a system can be provided. The system includes one or more processors; and a non-transitory computer-readable medium memory coupled to the one or more processors, the non-transitory computer-readable medium memory storing instructions that, when executed by the one or more processors, cause the one or more processors to perform a method for generative artificial intelligence of user interactions with a network site during a network session, the method including: obtaining, from a capture agent on a user device, captured data for a set of captured user interactions with at least one network site during a set of network sessions, where the set of captured user interactions includes (1) movements between portions of the at least one network site and (2) timestamps for one or more events during the set of network sessions; receiving a request for a set of combined textual descriptions corresponding to the set of network sessions; generating a prompt for a language model using the request; providing the prompt and event data of the set of network sessions as inputs to the language model, the prompt instructing the language model to identify a plurality of intents within the event data, each of the plurality of intents relating to a group of events that occurred within the set of network sessions, where each group of events occurred between a first timestamp and a last timestamp that are specific to each group of events; obtaining, as an output from the language model, the set of combined textual descriptions, each textual description of the set of combined textual descriptions summarizing the events included in each group of events, where the events are linked to timestamps corresponding to the events, where, for each group of events, the timestamps are within the first timestamp and the last timestamp that are specific to the group of events; and providing the set of combined textual descriptions to one or more computers associated with the network site.

In various embodiments, a system can be provided. The system includes one or more processors; and a non-transitory computer-readable medium memory coupled to the one or more processors, the non-transitory computer-readable medium memory storing instructions that, when executed by the one or more processors, cause the one or more processors to perform a method for generative artificial intelligence of user interactions with a network site during a set of network sessions, the method including: for each network session of the set of network sessions: obtaining, from a capture agent on a user device, captured data for a set of captured user interactions with the network site during the network session, where the set of captured user interactions includes movements between portions of the network site, and generating, by a language model, a session-specific textual description of the network session using the captured data, thereby generating a set of session-specific textual descriptions; receiving a request for a combined textual description of the set of network sessions; generating a prompt for the language model using the request; providing the prompt and the session-specific textual descriptions as inputs to the language model; receiving the combined textual description from the language model; and providing the combined textual description to a computer associated with the network site.

### IX. Example Computer System

Any of the computer systems (or “systems”) mentioned herein may utilize any suitable number of subsystems. Examples of such subsystems are in computer system 10 of FIG. 15. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 15 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g., Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer-readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, any related art or object-oriented techniques. The software code may be stored as a series of instructions or commands on a computer-readable medium for storage and/or transmission. A suitable non-transitory computer-readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer-readable medium may be any combination of such storage or transmission devices.

Such programs may also be encoded and transmitted using carrier signals adapted for transmission via wired, optical, and/or wireless networks conforming to a variety of protocols, including the Internet. As such, a computer-readable medium may be created using a data signal encoded with such programs. Computer-readable media encoded with the program code may be packaged with a compatible device or provided separately from other devices (e.g., via Internet download). Any such computer-readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

What is claimed is:

1. A method for generative artificial intelligence of user interactions with a network site during a network session, the method being performed by one or more processors of a computer system and comprising:
obtaining, from a capture agent on a user device, captured data for a set of captured user interactions with the network site during the network session, wherein the set of captured user interactions includes movements between portions of the network site;
analyzing the captured data to identify a set of events;
extracting event data corresponding to the set of events;
receiving a request for a textual description of the network session;
generating a prompt for a language model, using the request and the event data;
providing the prompt as an input to the language model;
receiving the textual description from the language model; and
providing the textual description to a computer associated with the network site.

2. The method of claim 1, wherein the set of captured user interactions further includes data provided in one or more fields on the network site.

3. The method of claim 1, wherein the textual description includes an outcome indicating that a user intent with regard to the network session was not accomplished, and
wherein the method further comprises:
identifying, by the language model, a most significant blocker that substantially contributed to the user intent not being accomplished; and
providing, by the language model for the most significant blocker, information including an event name, an event value, and a blocker timestamp.

4. The method of claim 3, wherein the set of captured user interactions with the network site during the network session includes interactions between the network site and a plurality of user devices operated by a plurality of users, and
the method further comprises:
providing a user interface for a client device to view a playback of a replay session of the network session; and
responsive to a client input via the user interface, providing, to the client device, information related to a set of user devices that encountered the most significant blocker among the plurality of user devices.

5. The method of claim 4, wherein the information related to the set of user devices comprises information about a number of user devices included in the set of user devices.

6. The method of claim 5, wherein the information related to the set of user devices further comprises information about a change in the number of user devices over time.

7. The method of claim 1, further comprising:
storing the event data at a storage location accessible by the language model.

8. A method for generative artificial intelligence of user interactions with a network site during a network session, the method being performed by one or more processors of a computer system and comprising:
obtaining, from a capture agent on a user device, captured data for a set of captured user interactions with the network site during the network session, wherein the set of captured user interactions includes (1) movements between portions of the network site and (2) timestamps for one or more events during the network session;
generating, by a language model, a textual description of the network session using the captured data, the textual description summarizing the one or more events, the one or more events being linked to the timestamps corresponding to the one or more events;
providing a user interface for a client device to view a playback of a replay session of the network session, the user interface displaying a first indicator corresponding to a first event; and
responsive to a client interacting with the first indicator, providing, to the client device, the textual description corresponding to a timestamp that is associated with the first indicator and linked to the textual description.

9. The method of claim 8, wherein the set of captured user interactions further includes data provided in one or more fields on the network site.

10. The method of claim 8, wherein the textual description includes an outcome indicating that a user intent with regard to the network session was not accomplished, and
wherein the method further comprises:
identifying, by the language model, a most significant blocker that substantially contributed to the user intent not being accomplished; and
providing, by the language model for the most significant blocker, information including an event name, an event value, and a blocker timestamp.

11. The method of claim 10, wherein the set of captured user interactions with the network site during the network session includes interactions between the network site and a plurality of user devices operated by a plurality of users, and
the method further comprises, responsive to a client input via the user interface, providing, to the client device, information related to a set of user devices that encountered the most significant blocker among the plurality of user devices.

12. The method of claim 11, wherein the information related to the set of user devices comprises information about a number of user devices included in the set of user devices.

13. The method of claim 12, wherein the information related to the set of user devices further comprises information about a change in the number of user devices over time.

14. The method of claim 8, further comprising:
overlaying the playback of the replay session with graphical representations corresponding to spans, wherein each of the spans corresponds to a logical grouping of events representing a topic during the network session; and
responsive to the client interacting with one of the graphical representations, displaying a textual description that describes the topic occurring in a time period for the span corresponding to the one of the graphical representations.

15. A method for generative artificial intelligence of user interactions with a network site during a network session, the method being performed by one or more processors of a computer system and comprising:
obtaining, from a capture agent on a user device, captured data for a set of captured user interactions with at least one network site during a set of network sessions, wherein the set of captured user interactions includes (1) movements between portions of the at least one network site and (2) timestamps for one or more events during the set of network sessions;
receiving a request for a set of combined textual descriptions corresponding to the set of network sessions;
generating a prompt for a language model using the request;
providing the prompt and event data of the set of network sessions as inputs to the language model, the prompt instructing the language model to identify a plurality of intents within the event data, each of the plurality of intents relating to a group of events that occurred within the set of network sessions, wherein each group of events occurred between a first timestamp and a last timestamp that are specific to each group of events;
obtaining, as an output from the language model, the set of combined textual descriptions, each textual description of the set of combined textual descriptions summarizing the events included in each group of events, wherein the events are linked to timestamps corresponding to the events, wherein, for each group of events, the timestamps are within the first timestamp and the last timestamp that are specific to the group of events; and
providing the set of combined textual descriptions to one or more computers associated with the network site.

16. The method of claim 15, further comprising:
providing a user interface for a client device to view a playback of a replay session of the network session;
responsive to a client interacting with the user interface, providing, to the client device, a plurality of textual descriptions from the set of combined textual descriptions; and
displaying, on the user interface, at least one of the plurality of textual descriptions in correspondence to the timestamps.

17. The method of claim 16, wherein the displaying further comprises:
overlaying the playback of the replay session with spans, wherein each of the spans corresponds to one of the plurality of textual descriptions and describes events occurring in a time period corresponding to each of the spans.

18. The method of claim 15, wherein the language model is a transformer.

19. A method for generative artificial intelligence of user interactions with a network site during a set of network sessions, the method being performed by one or more processors of a computer system and comprising:
for each network session of the set of network sessions:
obtaining, from a capture agent on a user device, captured data for a set of captured user interactions with the network site during the network session, wherein the set of captured user interactions includes movements between portions of the network site, and
generating, by a language model, a session-specific textual description of the network session using the captured data, thereby generating a set of session-specific textual descriptions;
receiving a request for a combined textual description of the set of network sessions;
generating a prompt for the language model using the request;
providing the prompt and the session-specific textual descriptions as inputs to the language model;
receiving the combined textual description from the language model; and
providing the combined textual description to a computer associated with the network site.

20. The method of claim 19, wherein the language model is a transformer.
